(19) United States
(12) Patent Application Publication
(10) Pub. No.: US 2014/0088001 A1
(43) Pub. Date: Mar. 27, 2014

(54) METHODS FOR DIAGNOSING ORGAN SPECIFICITY OF GLUCOSE INTOLERANCE

(71) Applicant: Mayo Foundation for Medical Education and Research, (US)

(72) Inventor: ZengKui Guo, Rochester, MN (US)

(73) Assignee: Mayo Foundation for Medical Education and Research, Rochester, MN (US)

(21) Appl. No.: 13/794,276

(22) Filed: Mar. 11, 2013

Related U.S. Application Data
(60) Provisional application No. 61/705,526, filed on Sep. 25, 2012.

(51) Int. Cl. G06F 19/00

(52) U.S. Cl. CPC G06F 19/30
USPC 514/5.9; 702/19

(57) ABSTRACT

The present application pertains to a technique useful for the differentiation and diagnosis of organ specificity of hyperglycemia and glucose intolerance in type 2 diabetes, pre-diabetes or populations with risk to develop type 2 diabetes.

### CROSS REFERENCE TO RELATED APPLICATIONS

This application claims the benefit of priority of U.S. Prov. Appl. No. 61/705,526, filed Sep. 25, 2012, which is incorporated herein by reference in its entirety.

### TECHNICAL FIELD

The present application pertains to a technique useful for the differentiation and diagnosis of organ specificity of hyperglycemia and glucose intolerance in type 2 diabetes, pre-diabetes or populations with risk to develop type 2 diabetes.

### BACKGROUND

One conventional method of diagnosing diabetes utilizes an oral glucose tolerance test (OGTT). OGTT only tests blood glucose level and thus is unable to identify the malfunctioning organ(s) that cause hyperglycemia and glucose intolerance that signify diabetes. As such, there exists a need for diagnostic techniques that allow for the clinician to determine organ specificity of glucose intolerance, thereby by allowing the use of therapies targeting the affected organs. This application addresses this need and others.

### SUMMARY

The present application provides methods of diagnosing organ specificity of glucose intolerance in an individual, comprising:

determining total plasma glucose concentration and plasma glucose concentration coming from orally administered glucose for a plurality of blood samples collected from an individual, wherein the blood samples were collected from the individual at different time intervals after oral administration of a mixture comprising isotopically labeled glucose and unlabeled glucose;

determining total plasma glucose concentration for a blood sample collected from the individual before the oral administration;

calculating AUC_{muscle} for the individual, wherein AUC_{muscle} is the area-under-the-curve for a plot of the plasma glucose concentration coming from orally administered glucose (y-axis) versus time elapsed since the oral administration of the mixture (x-axis) for the plurality of blood samples;

calculating AUCₗᵢᵥₑᵣ for the individual, wherein AUCₗᵢᵥₑᵣ=AUCₜₒₜₐₗ−AUC_{muscle}, wherein AUCₜₒₜₐₗ is the area-under-the-curve for a plot of the total plasma glucose concentration (y-axis) versus time elapsed since the oral administration of the mixture (x-axis) for the plurality of blood samples;

diagnosing the individual as having liver type glucose intolerance, muscle type glucose intolerance, or mixed type glucose intolerance, wherein:

the individual has liver type glucose intolerance if the AUCₗᵢᵥₑᵣ for the individual is significantly greater than an average AUCₗᵢᵥₑᵣ for a control group of healthy individuals; and the AUC_{muscle} for the individual is not significantly greater than an average AUC_{muscle} for a control group of healthy individuals;

the individual has muscle type glucose intolerance if the AUC_{muscle} for the individual is significantly greater than the average AUC_{muscle} for the control group of healthy individuals, but the AUCₗᵢᵥₑᵣ for the individual is not significantly greater than the average AUCₗᵢᵥₑᵣ for the control group of healthy individuals; and

the individual has mixed type glucose intolerance if the AUCₗᵢᵥₑᵣ for the individual is significantly greater than the average AUCₗᵢᵥₑᵣ for the control group of healthy individuals; and the AUC_{muscle} for the individual is significantly greater than the average AUC_{muscle} for the control group of healthy individuals.

The present application further provides methods of diagnosing organ specificity of glucose intolerance in an individual, comprising:

administering a mixture comprising isotopically labeled glucose and unlabeled glucose to an individual;

collecting a plurality of blood samples at different time intervals after the administering;

collecting a blood sample from the individual before the administering;

determining total plasma glucose concentration and plasma glucose concentration coming from orally administered glucose for the plurality of blood samples collected from the individual;

determining total plasma glucose concentration for the blood sample collected from the individual before the administering;

calculating AUC_{muscle} for the individual, wherein AUC_{muscle} is the area-under-the-curve for a plot of the plasma glucose concentration coming from orally administered glucose (y-axis) versus time elapsed since the oral administration of the mixture (x-axis) for the plurality of blood samples;

calculating AUCₗᵢᵥₑᵣ for the individual, wherein AUCₗᵢᵥₑᵣ=AUCₜₒₜₐₗ−AUC_{muscle}, wherein AUCₜₒₜₐₗ is the area-under-the-curve for a plot of the total plasma glucose concentration (y-axis) versus time elapsed since the oral administration of the mixture (x-axis) for the plurality of blood samples;

diagnosing the individual as having liver type glucose intolerance, muscle type glucose intolerance, or mixed type glucose intolerance, wherein:

the individual has liver type glucose intolerance if the AUCₗᵢᵥₑᵣ for the individual is significantly greater than an average AUCₗᵢᵥₑᵣ for a control group of healthy individuals; and the AUC_{muscle} for the individual is not significantly greater than an average AUC_{muscle} for a control group of healthy individuals;

the individual has muscle type glucose intolerance if the AUC_{muscle} for the individual is significantly greater than the average AUC_{muscle} for the control group of healthy individuals, but the AUCₗᵢᵥₑᵣ for the individual is not significantly greater than average AUCₗᵢᵥₑᵣ for the control group of healthy individuals; and

the individual has mixed type glucose intolerance if the AUCₗᵢᵥₑᵣ for the individual is significantly greater than the average AUCₗᵢᵥₑᵣ for the control group of healthy individuals; and the AUC_{muscle} for the individual is significantly greater than the average AUC_{muscle} for the control group of healthy individuals.

The present application also provides methods of diagnosing organ specificity of glucose intolerance in an individual, comprising:

determining total plasma glucose concentration and plasma glucose concentration coming from orally administered glucose for a plurality of blood samples collected from an individual, wherein the blood samples were collected from the individual at different time intervals after oral administration of a mixture comprising isotopically labeled glucose and unlabeled glucose;

determining total plasma glucose concentration for a blood sample collected from the individual before the oral administration;

calculating AUC_{muscle} for the individual, wherein AUC_{muscle} is the area-under-the-curve for a plot of the plasma glucose concentration coming from orally administered glucose (y-axis) versus time elapsed since the oral administration of the mixture (x-axis) for the plurality of blood samples;

calculating AUCₗᵢᵥₑᵣ for the individual, wherein AUCₗᵢᵥₑᵣ=AUCₜₒₜₐₗ−AUC_{muscle}, wherein AUCₜₒₜₐₗ is the area-under-the-curve for a plot of the total plasma glucose concentration (y-axis) versus time elapsed since the oral administration of the mixture (x-axis) for the plurality of blood samples;

calculating GII_{muscle} (skeletal muscle glucose intolerance index) for the individual by dividing the AUC_{muscle} for the individual by an average AUC_{muscle} for a control group of healthy individuals;

calculating GIIₗᵢᵥₑᵣ (heptatic glucose intolerance index) for the individual by dividing the AUCₗᵢᵥₑᵣ for the individual by an average AUCₗᵢᵥₑᵣ for the control group of healthy individuals;

calculating ΔGII_{muscle}, wherein ΔGII_{muscle}=GII_{muscle}−1.0;

calculating ΔGIIₗᵢᵥₑᵣ, wherein ΔGIIₗᵢᵥₑᵣ=GIIₗᵢᵥₑᵣ−1.0;

diagnosing the individual as having liver type glucose intolerance, muscle type glucose intolerance, or mixed type glucose intolerance, wherein:

the individual has liver type glucose intolerance if the ΔGIIₗᵢᵥₑᵣ for the individual is at least 3 times the standard deviation for an average GIIₗᵢᵥₑᵣ for the control group of healthy individuals; and the ΔGII_{muscle} for the individual is less than 3 times the standard deviation for an average GII_{muscle} for the control group of healthy individuals;

the individual has muscle type glucose intolerance if the ΔGII_{muscle} for the individual is at least 3 times the standard deviation for the average GII_{muscle} for the control group of healthy individuals, but the ΔGIIₗᵢᵥₑᵣ for the individual is less than 3 times the standard deviation for the average GIIₗᵢᵥₑᵣ for the control group of healthy individuals; and the individual has mixed type glucose intolerance if the ΔGIIₗᵢᵥₑᵣ for the individual is at least 3 times the standard deviation for the average GIIₗᵢᵥₑᵣ for the control group of healthy individuals; and the ΔGII_{muscle} for the individual is at least 3 times the standard deviation for the average GII_{muscle} for the control group of healthy individuals.

The present application further provides methods of diagnosing organ specificity of glucose intolerance in an individual, comprising:

administering a mixture comprising isotopically labeled glucose and unlabeled glucose to an individual;

collecting a plurality of blood samples at different time intervals after the administering;

collecting a blood sample from the individual before the administering;

determining total plasma glucose concentration and plasma glucose concentration coming from orally administered glucose for the plurality of blood samples collected from the individual;

determining total plasma glucose concentration for the blood sample collected from the individual before the administering;

calculating AUC_{muscle} for the individual, wherein AUC_{muscle} is the area-under-the-curve for a plot of the plasma glucose concentration coming from orally administered glucose (y-axis) versus time elapsed since the oral administration of the mixture (x-axis) for the plurality of blood samples;

calculating AUCₗᵢᵥₑᵣ for the individual, wherein AUCₗᵢᵥₑᵣ=AUCₜₒₜₐₗ−AUC_{muscle}, wherein AUCₜₒₜₐₗ is the area-under-the-curve for a plot of the total plasma glucose concentration (y-axis) versus time elapsed since the oral administration of the mixture (x-axis) for the plurality of blood samples;

calculating GII_{muscle} (skeletal muscle glucose intolerance index) for the individual by dividing the AUC_{muscle} for the individual by an average AUC_{muscle} for a control group of healthy individuals;

calculating GIIₗᵢᵥₑᵣ (heptatic glucose intolerance index) for the individual by dividing the AUCₗᵢᵥₑᵣ for the individual by an average AUCₗᵢᵥₑᵣ for the control group of healthy individuals;

calculating ΔGII_{muscle}, wherein ΔGII_{muscle}=GII_{muscle}−1.0;

calculating ΔGIIₗᵢᵥₑᵣ, wherein ΔGIIₗᵢᵥₑᵣ=GIIₗᵢᵥₑᵣ−1.0;

diagnosing the individual as having liver type glucose intolerance, muscle type glucose intolerance, or mixed type glucose intolerance, wherein:

the individual has liver type glucose intolerance if the ΔGIIₗᵢᵥₑᵣ for the individual is at least 3 times the standard deviation for an average GIIₗᵢᵥₑᵣ for the control group of healthy individuals; and the ΔGII_{muscle} for the individual is less than 3 times the standard deviation for an average GII_{muscle} for the control group of healthy individuals; and

the individual has muscle type glucose intolerance if the ΔGII_{muscle} for the individual is at least 3 times the standard deviation for the average GII_{muscle} for the control group of healthy individuals, but the ΔGIIₗᵢᵥₑᵣ for the individual is less than 3 times the standard deviation for the average GIIₗᵢᵥₑᵣ for the control group of healthy individuals; and

the individual has mixed type glucose intolerance if the ΔGIIₗᵢᵥₑᵣ for the individual is at least 3 times the standard deviation for the average GIIₗᵢᵥₑᵣ for the control group of healthy individuals; and the ΔGII_{muscle} for the individual is at least 3 times the standard deviation for the average GII_{muscle} for the control group of healthy individuals.

In some embodiments, the methods further comprise treating the individual with a therapy suited to muscle type glucose intolerance if the individual is diagnosed as having muscle type glucose intolerance; or treating the individual with a therapy suited to liver type glucose intolerance if the individual is diagnosed as having liver type glucose intolerance; or treating the individual with a therapy suited to mixed type glucose intolerance if the individual is diagnosed as having mixed type glucose intolerance.

### DESCRIPTION OF DRAWINGS

FIG. 1 depicts the total plasma glucose concentration (open circles) and plasma glucose concentration coming from orally administered glucose (closed circles) for a representative individual from a healthy control group of individuals.

FIG. 2 depicts the total plasma glucose concentration (open circles) and plasma glucose concentration coming from orally administered glucose (closed circles) for an individual having liver type glucose intolerance.

FIG. 3 depicts the total plasma glucose concentration (open circles) and plasma glucose concentration coming from orally administered glucose (closed circles) for an individual having muscle type glucose intolerance.

FIG. 4 depicts the total plasma glucose concentration (open circles) and plasma glucose concentration coming from orally administered glucose (closed circles) for an individual having mixed type glucose intolerance.

FIG. 5 depicts clinical subtyping for several individuals suffering from obesity or type 2 diabetes, wherein the length of the horizontal bars (left to the central zero line) is the values of ΔGII_{muscle} (i.e. the severity of muscle type glucose intolerance) or the length of the horizontal bars (right to the central zero line) the values of ΔGIIₗᵢᵥₑᵣ (i.e. the severity of liver type glucose intolerance); to the left of the horizontal bar graph shown are plasma insulin levels and profiles for these individuals during the OGTT using the techniques as described in this application.

Like reference symbols in the various drawings indicate like elements.

### DETAILED DESCRIPTION

The present application provides, inter alia, a technique that can be used for the diagnosis of diseased organs (the liver or peripheral tissues, primarily skeletal muscle) that are responsible for hyperglycemia in type 2 diabetes, pre-diabetes, or other populations at risk to develop type 2 diabetes (e.g., the elderly and individuals suffering from obesity). Individuals with impaired glucose tolerance (i.e. glucose intolerance) in the liver are called liver type; the patients with peripheral tissues (primarily skeletal muscle) of impaired glucose tolerance are called muscle type; and the patients who meet both criteria for both types are called mixed type.

Accordingly, in some embodiments, the present application provides a method of diagnosing organ specificity of glucose intolerance in an individual, comprising:

determining total plasma glucose concentration and plasma glucose concentration coming from orally administered glucose for a plurality of blood samples collected from an individual, wherein the blood samples were collected from the individual at different time intervals after oral administration of a mixture comprising isotopically labeled glucose and unlabeled glucose;

determining total plasma glucose concentration for a blood sample collected from the individual before the oral administration;

calculating AUC_{muscle} for the individual, wherein AUC_{muscle} is the area-under-the-curve for a plot of the plasma glucose concentration coming from orally administered glucose (y-axis) versus time elapsed since the oral administration of the mixture (x-axis) for the plurality of blood samples;

calculating AUCₗᵢᵥₑᵣ for the individual, wherein AUCₗᵢᵥₑᵣ=AUCₜₒₜₐₗ−AUC_{muscle},

wherein AUCₜₒₜₐₗ is the area-under-the-curve for a plot of the total plasma glucose concentration (y-axis) versus time elapsed since the oral administration of the mixture (x-axis) for the plurality of blood samples;

diagnosing the individual as having liver type glucose intolerance, muscle type glucose intolerance, or mixed type glucose intolerance, wherein:

the individual has liver type glucose intolerance if the AUCₗᵢᵥₑᵣ for the individual is significantly greater than an average AUCₗᵢᵥₑᵣ for a control group of healthy individuals; and the AUC_{muscle} for the individual is not significantly greater than an average AUC_{muscle} for the control group of healthy individuals;

the individual has muscle type glucose intolerance if the AUC_{muscle} for the individual is significantly greater than the average AUC_{muscle} for the control group of healthy individuals, but the AUCₗᵢᵥₑᵣ for the individual is not significantly greater than the average AUCₗᵢᵥₑᵣ for the control group of healthy individuals; and

the individual has mixed type glucose intolerance if the AUCₗᵢᵥₑᵣ for the individual is significantly greater than the average AUCₗᵢᵥₑᵣ for the control group of healthy individuals; and the AUC_{muscle} for the individual is significantly greater than the average AUC_{muscle} for the control group of healthy individuals.

In some embodiments, the individual has liver type glucose intolerance if the AUCₗᵢᵥₑᵣ for the individual is at least 3 times the standard deviation for an average AUCₗᵢᵥₑᵣ for a control group of healthy individuals; and the AUC_{muscle} for the individual is less than 3 times the standard deviation for an average AUC_{muscle} for the control group of healthy individuals;

the individual has muscle type glucose intolerance if the AUC_{muscle} for the individual is at least 3 times the standard deviation for the average AUC_{muscle} for the control group of healthy individuals, but the AUCₗᵢᵥₑᵣ for the individual is less than 3 times the standard deviation for the average AUCₗᵢᵥₑᵣ for the control group of healthy individuals; and

the individual has mixed type glucose intolerance if the AUCₗᵢᵥₑᵣ for the individual is at least 3 times the standard deviation for the average AUCₗᵢᵥₑᵣ for the control group of healthy individuals; and the AUC_{muscle} for the individual is at least 3 times the standard deviation for the average AUC_{muscle} for the control group of healthy individuals.

In another embodiment, the present application provides a method of diagnosing organ specificity of glucose intolerance in an individual, comprising:

determining total plasma glucose concentration and plasma glucose concentration coming from orally administered glucose for a plurality of blood samples collected from an individual, wherein the blood samples were collected from the individual at different time intervals after oral administration of a mixture comprising isotopically labeled glucose and unlabeled glucose;

determining total plasma glucose concentration for a blood sample collected from the individual before the oral administration;

calculating AUC_{muscle} for the individual, wherein AUC_{muscle} is the area-under-the-curve for a plot of the plasma glucose concentration coming from orally administered glucose (y-axis) versus time elapsed since the oral administration of the mixture (x-axis) for the plurality of blood samples;

calculating AUCₗᵢᵥₑᵣ for the individual, wherein AUCₗᵢᵥₑᵣ=AUCₜₒₜₐₗ−AUC_{muscle}, wherein AUCₜₒₜₐₗ is the area-under-the-curve for a plot of the total plasma glucose concentration (y-axis) versus time elapsed since the oral administration of the mixture (x-axis) for the plurality of blood samples;

calculating GII_{muscle} (skeletal muscle glucose intolerance index) for the individual by dividing the AUC_{muscle} for the individual by an average AUC_{muscle} for a control group of healthy individuals;

calculating GIIₗᵢᵥₑᵣ (heptatic glucose intolerance index) for the individual by dividing the AUCₗᵢᵥₑᵣ for the individual by an average AUCₗᵢᵥₑᵣ for the control group of healthy individuals;

calculating ΔGII_{muscle}, wherein ΔGII_{muscle}=GII_{muscle}−1.0;

calculating ΔGIIₗᵢᵥₑᵣ, wherein ΔGIIₗᵢᵥₑᵣ=GIIₗᵢᵥₑᵣ−1.0;

diagnosing the individual as having liver type glucose intolerance, muscle type glucose intolerance, or mixed type glucose intolerance, wherein:

the individual has liver type glucose intolerance if the ΔGIIₗᵢᵥₑᵣ for the individual is at least 3 times the standard deviation for an average GIIₗᵢᵥₑᵣ for the control group of healthy individuals; and the ΔGII_{muscle} for the individual is less than 3 times the standard deviation for an average GII_{muscle} for the control group of healthy individuals;

the individual has muscle type glucose intolerance if the ΔGII_{muscle} for the individual is at least 3 times the standard deviation for the average GII_{muscle} for the control group of healthy individuals, but the ΔGIIₗᵢᵥₑᵣ for the individual is less than 3 times the standard deviation for the average GIIₗᵢᵥₑᵣ for the control group of healthy individuals; and

the individual has mixed type glucose intolerance if the ΔGIIₗᵢᵥₑᵣ for the individual is at least 3 times the standard deviation for the average GIIₗᵢᵥₑᵣ for the control group of healthy individuals; and the ΔGII_{muscle} for the individual is at least 3 times the standard deviation for the average GII_{muscle} for the control group of healthy individuals.

In some embodiments of the methods described herein, isotopically labeled glucose is mixed with a dose of regular glucose to be ingested by a patient. As used herein, isotopically labeled glucose means glucose, wherein one or more H, C, and/or O atoms of the glucose molecule are replaced by deuterium, ¹³C, or ¹⁸O atoms, respectively,

wherein the deuterium atoms are bound to carbon atoms. In some embodiments, the isotopically labeled glucose is glucose, wherein one or more C—H groups are replaced by C-D groups. In some embodiments, the isotopically labeled glucose is 6,6-d₂-D-glucose. In some embodiments, the mixture comprises 1% to 3% (w/w) isotopically labeled glucose based on the total weight of labeled and unlabeled glucose. In some embodiments, the mixture comprises 1% to 3% (w/w) 6,6-d₂-D-glucose based on the total weight of labeled and unlabeled glucose.

Blood samples can then be collected immediately prior to the glucose ingestion (e.g., a baseline sample at 0 minutes) and periodically post-ingestion, usually up to 3 hours. In some embodiments, the blood samples are collected over at least a two hour period after the oral administration. In some embodiments, the blood samples are collected over at least a three hour period after the oral administration. In some embodiments, the blood samples are collected at about 30 minutes, about 60 minutes, about 90 minutes, about 120 minutes, about 150 minutes, and about 180 minutes after the oral administration of the mixture. In some embodiments, the blood sample collected before the oral administration is collected within 15 minutes of the oral administration.

The blood samples can first be individually processed to purify glucose using chemical solvents. The samples can then be analyzed mass spectrometry (e.g., LC-MS or GC-MS) and a glucose analyzer to produce two dynamic curves for each individual. For example, the total plasma glucose concentration for each blood sample can be measured by using a glucose analyzer (e.g., a glucose oxidase analyzer, such as that provided by Yellow Springs Instruments, Yellow Springs, Ohio).

The plasma glucose concentration coming from orally administered glucose can be measured by a mass spectrometry technique (e.g., LC-MS or GC-MS). In particular, the plasma glucose concentration coming from orally administered glucose for each blood sample can be determined by measuring the molecular ion peak area for the isotopically labeled glucose (PA_{tracer-sample}) and the molecular ion peak area for unlabeled glucose (PA_{tracee-sample}) by liquid chromatography-mass spectrometry or gas chromatography-mass spectrometry for each blood sample; calculating molar percent excess for each blood sample (MPEₛₐₘₚₗₑ) by dividing PA_{tracer-sample} by the sum of PA_{tracer-sample} and PA_{tracee-sample} for the blood sample; measuring the molecular ion peak area for isotopically labeled glucose in the mixture (PA_{tracer-mixture}) and the molecular ion peak area for unlabeled glucose in the mixture (PA_{tracee-mixture}) by liquid chromatography-mass spectrometry or gas chromatography-mass spectrometry; calculating molar percent excess for the mixture (MPEₘᵢₓₜᵤᵣₑ) by dividing PA_{tracer-mixture} by the sum of PA_{tracer-mixture} and PA_{tracee-mixture}; calculating the plasma glucose concentration coming from orally administered glucose for each blood sample by multiplying the total plasma glucose concentration for the blood sample by the ratio of MPEₛₐₘₚₗₑ/MPEₘᵢₓₜᵤᵣₑ for the blood sample.

In some embodiments, each blood sample is measured individually. In some embodiments, each blood sample is first derivatized (reacted, tagged) with a chemical tag before the liquid chromatography-mass spectrometry or gas chromatography-mass spectrometry is conducted. In other embodiments, the blood samples are derivatized with a chemical tag having the same chemical structure, but different isotopic substitution pattern and then mixed and analyzed together as described below.

When the total plasma glucose concentration and the plasma glucose concentration coming from orally administered glucose are plotted against the time after administration, they produce two dynamic curves. The area-under-the curve (AUC) for total plasma glucose concentration curve and the plasma glucose concentration coming from orally administered glucose curve can then be determined by normal techniques, producing AUCₜₒₜₐₗ and AUCₒᵣₐₗ. AUCₜₒₜₐₗ corresponds to the total glucose concentration, whereas AUCₒᵣₐₗ corresponds to the plasma glucose concentration coming from orally administered glucose. AUCₒᵣₐₗ also corresponds to AUC_{muscle}, which is in an inverse relationship with the extent of glucose uptake; that is, the smaller an AUC_{muscle} value is, the more glucose is taken up and vice versa. The difference between the AUC values (AUCₒᵣₐₗ and AUCₜₒₜₐₗ) corresponds to the concentration of endogenously produced glucose. This difference corresponds to AUCₗᵢᵥₑᵣ. AUCₗᵢᵥₑᵣ is proportional to endogenous glucose production (EGP); that is, a small AUCₗᵢᵥₑᵣ indicates low EGP (i.e. effective suppression of EGP by insulin), and vice versa.

Similar testing can be carried out on a control group of healthy individuals to determine an average AUCₗᵢᵥₑᵣ and an average AUC_{muscle} for a healthy control group of individuals for comparison to the values obtained for the individuals (e.g., patients) above. Accordingly, in some embodiments, an average AUC_{muscle} and an average AUCₗᵢᵥₑᵣ for the control group of healthy individuals is measured by a method comprising determining total plasma glucose concentration and plasma glucose concentration coming from orally administered glucose for a plurality of blood samples collected from a healthy individual, wherein the blood samples were collected from the healthy individual at different time intervals after oral administration of a mixture comprising isotopically labeled glucose and unlabeled glucose; determining total plasma glucose concentration for a blood sample collected from the healthy individual before the oral administration (e.g., a baseline sample); calculating AUC_{muscle} for the healthy individual, wherein AUC_{muscle} is the area-under-the-curve for a plot of the plasma glucose concentration coming from orally administered glucose (y-axis) versus time elapsed since the oral administration of the mixture (x-axis) for the plurality of blood samples; calculating AUCₗᵢᵥₑᵣ for the healthy individual, wherein AUCₗᵢᵥₑᵣ=AUCₜₒₜₐₗ−AUC_{muscle}, AUC_{muscle}, AUCₜₒₜₐₗ is the area-under-the-curve for a plot of the total plasma glucose concentration (y-axis) versus time elapsed since the oral administration of the mixture (x-axis) for the plurality of blood samples; repeating the previous steps for additional individual in the healthy control group; and averaging AUC_{muscle} and AUCₗᵢᵥₑᵣ for the control group of healthy individuals to obtain the average AUC_{muscle} for the control group of healthy individuals and the average AUCₗᵢᵥₑᵣ for the control group of healthy individuals.

A comparison can then be made between AUCₗᵢᵥₑᵣ and AUC_{muscle} for the individual (e.g., the patient) and the average AUCₗᵢᵥₑᵣ and the average AUC_{muscle} for the control group of healthy individuals. This enables diagnosis of organ specificity for glucose intolerance in the individual. Accordingly, in some embodiments, the method comprises diagnosing the individual as having liver type glucose intolerance, muscle type glucose intolerance, or mixed type glucose intolerance, wherein the individual has mixed type glucose intolerance if AUCₗᵢᵥₑᵣ for the individual is at least 3 times the standard deviation for an average AUCₗᵢᵥₑᵣ for a control group of healthy individuals; and AUC_{muscle} for the individual is at least 3 times the standard deviation for an average AUC_{muscle} for a control group of healthy individuals; the individual has liver type glucose intolerance if AUCₗᵢᵥₑᵣ for the individual is at least 3 times the standard deviation for an average AUCₗᵢᵥₑᵣ for a control group of healthy individuals; and AUC_{muscle} for the individual is less than 3 times the standard deviation for an average AUC_{muscle} for a control group of healthy individuals; and the individual has muscle type glucose intolerance if AUC_{muscle} for the individual is at least 3 times the standard deviation for an average AUC_{muscle} for a control group of healthy individuals, but AUCₗᵢᵥₑᵣ for the individual is less than 3 times the standard deviation for an average AUCₗᵢᵥₑᵣ for a control group of healthy individuals.

For liver type glucose intolerance, during fasting, blood glucose comes mainly from the liver via gluconeogenesis (endogenous glucose production, EGP). During OGTT, an oral dose of glucose is administered. Blood insulin level rapidly increases in response to the incoming glucose. Under insulin actions, EGP is largely suppressed and circulating blood glucose mostly comes from the oral dose of glucose. Thus, the isotope enrichment of blood glucose is the same as or near that of the oral glucose dose depending on the extent of EGP suppression. When liver becomes insulin resistant as in some diabetics, EGP is not suppressed or less suppressed and endogenously produced glucose continues comes into circulation. Together with incoming oral glucose, this causes great excursion of blood glucose. During this process, unlabeled endogenous glucose dilutes the glucose isotope contained in the incoming oral glucose that is labeled. Therefore, the enrichment of blood glucose isotope is decreased compared to that of the oral glucose. The degree of the decrease is proportional to the degree of endogenous glucose that comes into circulation. Thus, by quantifying the extent of the decrease in enrichment of blood glucose, the degree of impairment in EGP suppression can be determined. In some embodiments, the orally originated glucose in plasma is determined first as described above.

By contrast, in individuals with peripheral (primarily skeletal muscle because it is responsible for 80% of insulin-stimulated glucose disposal) but not hepatic glucose intolerance, EGP is effectively suppressed by insulin and thus there is no or less endogenous glucose coming into circulation. Thus, incoming oral glucose is not diluted isotopically. However, with peripheral tissue insulin resistance, the utilization of glucose is impaired. This causes decrease and delay in clearance of incoming oral glucose from the circulation. This results in higher, prolonged blood glucose concentration. Based on the isotopic enrichment and concentration of blood glucose, the degree of impairment in glucose uptake by peripheral tissues (glucose intolerance) is quantified.

In some embodiments of the methods described herein, additional calculations are made to more easily decipher the results. Accordingly, in some embodiments, the method comprises calculating GII_{muscle} (skeletal muscle glucose intolerance index) for the individual by dividing the AUC_{muscle} for the individual by an average AUC_{muscle} for a control group of healthy individuals; calculating GIIₗᵢᵥₑᵣ (heptatic glucose intolerance index) for the individual by dividing the AUCₗᵢᵥₑᵣ for the individual by an average AUCₗᵢᵥₑᵣ for the control group of healthy individuals; calculating ΔGII_{muscle}, wherein ΔGII_{muscle}=GII_{muscle}−1.0; and calculating ΔGIIₗᵢᵥₑᵣ, wherein ΔGIIₗᵢᵥₑᵣ−1.0.

The individual can then be diagnosed as having liver type glucose intolerance, muscle type glucose intolerance, or mixed type glucose intolerance, wherein the individual has mixed type glucose intolerance if the ΔGIIₗᵢᵥₑᵣ for the individual is at least 3 times the standard deviation for an average GIIₗᵢᵥₑᵣ for a control group of healthy individuals; and the ΔGII_{muscle} for the individual is at least 3 times the standard deviation for an average GII_{muscle} for the control group of healthy individuals; the individual has liver type glucose intolerance if the ΔGIIₗᵢᵥₑᵣ for the individual is at least 3 times the standard deviation for the average GIIₗᵢᵥₑᵣ for the control group of healthy individuals; and the ΔGII_{muscle} for the individual is less than 3 times the standard deviation for the average GII_{muscle} for the control group of healthy individuals; and the individual has muscle type glucose intolerance if the ΔGII_{muscle} for the individual is at least 3 times the standard deviation for the average GII_{muscle} for the control group of healthy individuals; and the ΔGIIₗᵢᵥₑᵣ for the individual is less than 3 times the standard deviation for the average GIIₗᵢᵥₑᵣ for the control group of healthy individuals.

In some embodiments, the methods described herein further comprise treating the individual with a therapy suited to muscle type glucose intolerance if the individual is diagnosed as having muscle type glucose intolerance; or treating the individual with a therapy suited to liver type glucose intolerance if the individual is diagnosed as having liver type glucose intolerance; or treating the individual with a therapy suited to mixed type glucose intolerance if the individual is diagnosed as having mixed type glucose intolerance. The following examples of directed treatments are given for illustrative purposes. Clinically, metformin is the first line of choice of therapy prescribed to the treatment of hyperglycemia. It works primarily by suppressing EGP and, therefore, is suited for liver type glucose intolerance. By comparison, thiazolidinediones (TZD) such as pioglitazone is an insulin-sensitizer. It works primarily by stimulating glucose uptake by peripheral tissues (skeletal muscle and adipose tissue) and, therefore, is suited for muscle type glucose intolerance. For insulin-deficient patients, sulfonylurea drugs are usually given to stimulate insulin secretion. Alternatively, insulin itself is given to increase plasma insulin level. It is the doctor's professionalism to determine the effective combination of many antidiabetic medications for the best outcome of glycemic control.

In some embodiments, the method further comprises determining plasma insulin concentration for the plurality of blood samples collected from the individual; determining plasma insulin concentration for the blood sample collected from the individual before the oral administration; and determining whether the plasma insulin concentration versus time profile is normal or abnormal.

In some embodiments, the method further comprises treating the individual with a therapy suited to insulin deficiency if the plasma insulin concentration versus time profile is abnormal compared to the insulin profile for a healthy individual; or treating the individual with a therapy suited to muscle type glucose intolerance if the individual is diagnosed as having muscle type glucose intolerance and the plasma insulin concentration versus time profile is normal; or treating the individual with a therapy suited to liver type glucose intolerance if the individual is diagnosed as having liver type glucose intolerance and the plasma insulin concentration versus time profile is normal; or treating the individual with a therapy suited to mixed type glucose intolerance if the individual is diagnosed as having mixed type glucose intolerance and the plasma insulin concentration versus time profile is normal.

In some embodiments, the average AUC_{muscle} and the average AUCₗᵢᵥₑᵣ for the control group of healthy individuals is measured by a method described above and then average GII_{muscle} and average GIIₗᵢᵥₑᵣ, and standard deviation for each glucose intolerance index, is determined. Accordingly, in some embodiments, the standard deviation for GII_{muscle} for the control group of healthy individuals is calculated by dividing AUC_{muscle} for each healthy individual in the control group by the average AUC_{muscle} for the control group of healthy individuals to obtain GII_{muscle} for each healthy individual; and determining the standard deviation for GII_{muscle} for the control group of healthy individuals. In another embodiment, the standard deviation for GIIₗᵢᵥₑᵣ for the control group of healthy individuals is calculated by dividing AUCₗᵢᵥₑᵣ for each healthy individual in the control group by the average AUCₗᵢᵥₑᵣ for the control group of healthy individuals to obtain GIIₗᵢᵥₑᵣ for each healthy individual; and determining the standard deviation for GIIₗᵢᵥₑᵣ for the control group of healthy individuals.

In some embodiments of the methods, the purified glucose from each blood sample is chemically derivatized by one of the multiplex chemical tags that are structurally identical but differ in mass due to the number or/and type of stable isotopic labels contained in each tag (differentially-labeled isotopic chemical tags). Therefore, each derivatized glucose sample collected at one time point differs in mass from other samples collected from other time points from the same individual, enabling the analysis of the samples in a single LC-MS or GC-MS run.

Accordingly, in some embodiments, the method further comprises first derivatizing a portion of the mixture and a portion of each blood sample from the individual with a different chemical tag, wherein each chemical tag has the same structural formula but a different isotopic substitution pattern, wherein the molecular weights of each chemical tag differ by at least 4 Daltons; measuring the molecular ion peak area for each derivatized isotopically labeled glucose (PA_{tracer-sample}) and the molecular ion peak area for each derivatized unlabeled glucose (PA_{tracee-sample}) by liquid chromatography-mass spectrometry or gas chromatography-mass spectrometry for each blood sample; measuring the molecular ion peak area for the derivatized isotopically labeled glucose in the mixture (PA_{tracer-mixture}) and the molecular ion peak area for the derivatized unlabeled glucose in the mixture (PA trace-mixture) by liquid chromatography-mass spectrometry or gas chromatography-mass spectrometry; calculating molar percent excess for each blood sample (MPEₛₐₘₚₗₑ) by dividing PA_{tracer-sample} by the sum of PA_{tracer}-sample and PA_{tracee-sample} for the blood sample; calculating molar percent excess for the mixture (MPEₘᵢₓₜᵤᵣₑ) by dividing PA_{tracer-mixture} by the sum of PA_{tracer-mixture} and PA_{tracee-mixture}; and calculating the plasma glucose concentration coming from orally administered glucose for each blood sample by multiplying the total plasma glucose concentration for each blood sample by the ratio of MPEₛₐₘₚₗₑ/MPEₘᵢₓₜᵤᵣₑ for the blood sample.

In some embodiments, the method further comprises first derivatizing a portion of the mixture and a portion of each blood sample from the individual with a different chemical tag, wherein each chemical tag has the same structural formula but a different isotopic substitution pattern, wherein the molecular weights of each chemical tag differs by at least 4 Daltons; and analyzing the derivatized blood samples for the individual and the derivatized mixture in a single liquid chromatography-mass spectrometry or gas chromatography-mass spectrometry run.

In some embodiments, the chemical tags are a series of isotopically labeled 2-(4-phenylpiperazin-1-yl)ethanamines, wherein each tag in the series differs in molecular weight by at least 4 Daltons. In some embodiments, each tag in the series has a molecular weight of 204, 208, 212, 216, 220, 224, 228, and 232 Daltons. In the case of 6,6-d₂-D-glucose, this allows for clear separation of each molecular ion by 2 Daltons (wherein one peak is from derivatized/tagged 6,6-d₂-D-glucose and the other peak is from derivatized/tagged glucose). In some embodiments, the chemical tags are those described in U.S. Ser. No. 13/472,103, which is incorporated herein by reference in its entirety.

In some embodiments, the chemical tags are selected from a plurality of compounds of Formula I:

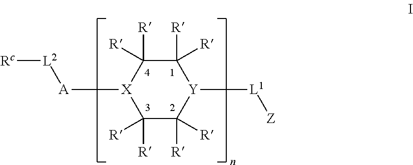

or salts thereof; comprising a non-isobaric series of compounds; wherein:

each compound in the series has the same structural formula but a different isotopic substitution pattern;

n is an integer selected from 0, 1, 2, or 3;

Z is selected from —C(═O)OR¹, —C(═O)X¹, and —NHR²;

X¹ is halogen;

R¹ and R² are each independently selected from H, C₁₋₆ alkyl, C₁₋₆ alkenyl, C₁₋₆ alkynyl, C₁₋₆ haloalkyl, C₆₋₁₀ aryl, C₆₋₁₀ aryl-C₁₋₃ alkyl, C₁₋₉ heteroaryl, C₁₋₉ heteroaryl-C₁₋₃ alkyl, C₃₋₇ cycloalkyl, C₂₋₉ heterocycloalkyl, C₃₋₇ cycloalkyl-C₁₋₃ alkyl, and C₂₋₉ heterocycloalkyl-C₁₋₃ alkyl; wherein the C₆₋₁₀ aryl, C₆₋₁₀ aryl-C₁₋₃ alkyl, C₁₋₉ heteroaryl, C₁-9 heteroaryl-C₁₋₃ alkyl, C₃₋₇ cycloalkyl, C₂₋₉ heterocycloalkyl, C₃₋₇ cycloalkyl-C₁₋₃ alkyl, and C₂₋₉ heterocycloalkyl-C₁₋₃ alkyl are each optionally substituted by 1, 2, 3, or 4 groups independently selected from halogen, cyano, nitro, C₁₋₄ alkyl, C₁₋₄ haloalkyl, C₁₋₄ alkoxy, and C₁₋₄ haloalkoxy;

R² is a protecting group;

X is selected from C(R′) and ¹³C(R′); and Y is selected from C(R′) and ¹³C(R′); or

X is selected from N and ¹⁵N; and Y is selected from N and ⁵N;

when n is 1, 2, or 3 and X is N or ¹⁵N, then A is absent; or

when (1) X is C(R′) or ¹³C(R′) and n is 1, 2, or 3; or (2) n is 0, then A is N(R^{f}), or ¹⁵N(R^{f});

L¹ is -G¹-G²-G³-G⁴-G⁵-G⁶-; wherein G¹ is attached to Z;

L² is -E¹-E²-E³-E⁴-E⁵-E⁶-E⁷-E⁸-; wherein E¹ is attached to A;

R^{f} is —F¹—F²—F³—F⁴—F⁵—F⁶—F⁷—F⁸—R^{e};

G¹ is —C(R^{a})₂— or —¹³C(R^{a})₂—;

G², G³, G⁴, G⁵, and G⁶ are each independently absent, —C(R^{a})₂—, or —¹³C(R^{a})₂—; E¹, E², E³, E⁴, E⁵, E⁶, E⁷, and E⁸ are each independently absent, —C(R^{b})₂—, or —¹³C(R^{b})₂—;

F¹, F², F³, F⁴, F⁵, F⁶, F⁷, and F⁸ are each independently absent, —C(R^{b})₂—, or —¹³C(R^{b′})₂—;

each R^{c} is independently selected from H and D;

each R^{a}, R^{b}, and R^{b′} is independently selected from H and D;

each R′ is independently selected from H and D; and

C1, C2, C3, and C4 of the ring are independently carbon or carbon-13.

As used herein, the term “non-isobaric series of compounds” means that each compound in the plurality has the same structural formula provided that each compound in the series has a different isotopic substitution pattern. A non-limiting example of a non-isobaric series of compounds would include three piperazinyl-methylamine compounds, one compound without any isotopic substitution; one compound wherein one carbon atom is replaced by ¹³C; and one compound wherein three carbon atoms are replaced by ¹³C.

In some embodiments, the plurality comprises at least 2, at least 3, at least 4, at least 5, at least 6, at least 7, at least 8, at least 9, at least 10, at least 11, at least 12, at least at least 13, at least 14, at least 15, at least 16, at least 17, at least 18, at least 19, at least 20, at least 21, at least 22, at least 23, at least 24, at least 25, at least 26, at least 27, at least 28, at least 29, at least 30, at least 31, at least 32, at least 33, at least 34, at least 35, at least 36, at least 37, at least 38, at least 39, 40, at least 41, at least 42, at least 43, at least 44, at least 45, at least 46, at least 47, at least 48, at least 49, at least 50, at least 51, at least 52, at least 53, at least 54, at least 55, at least 56, at least 57, at least 58, at least 59, at least 60, at least 61, at least 62, at least 63, at least 64, at least 65, at least 66, at least 67, at least 68, at least 69, at least 70, at least 71, at least 72, at least 73, at least 74, at least 75, at least 76, at least 77, at least 78, at least 79, at least 80, at least 81, at least 82, at least 83, at least 84, or at least 85 compounds. In some embodiments, the plurality comprises at least 16 compounds. In some embodiments, the plurality comprises at least 20 compounds. In some embodiments, the plurality comprises at least 22 compounds. In some embodiments, the plurality comprises at least 23 compounds. In some embodiments, the plurality comprises at least 36 compounds. In some embodiments, the plurality is selected from a non-isobaric series of 16 compounds. In some embodiments, the plurality is selected from a non-isobaric series of 20 compounds. In some embodiments, the plurality is selected from a non-isobaric series of 22 compounds. In some embodiments, the plurality is selected from a non-isobaric series of 23 compounds. In some embodiments, the plurality is selected from a non-isobaric series of 36 compounds. Each of these embodiments may also apply, as appropriate, to the plurality and kits described infra.

In some embodiments:

each compound has a formula weight which is 1 integer atomic mass unit higher than the previous compound in the plurality; and

the compound with the highest formula weight in the plurality is isotopically labeled with at least one of each of ¹³C, ¹⁵N, and D.

In some embodiments, the isotopic substitution in the plurality is D only. In some embodiments, the isotopic substitution in the plurality is ¹³C only. In some embodiments, the isotopic substitution in the plurality is ¹⁵N only.

In some embodiments:

each compound has a formula weight which is 1 integer atomic mass unit higher than the previous compound in the plurality;

the compound with the lowest formula weight in the plurality is not isotopically labeled with ¹³C, ¹⁵N, or D; and

the compound with the highest formula weight in the plurality is isotopically labeled with at least one of each of ¹³C, ¹⁵N, and D.

In some embodiments, R¹ and R² are each H.

In some embodiments, Z is —C(═O)OH. In some embodiments, Z is —NH₂.

In some embodiments, n is 0 or 1.

In some embodiments, the chemical tags are selected from a plurality of compounds of Formula II:

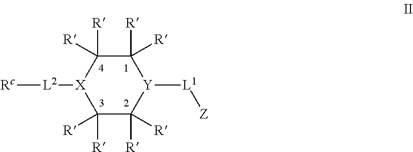

or salts thereof; wherein:

X is selected from N and ¹⁵N;

Y is selected from N and ¹⁵N.

In some embodiments, R¹ and R² are each H.

In some embodiments, Z is —C(═O)OH. In some embodiments, Z is —NH₂.

In some embodiments, L¹ is -G¹-G²-; wherein G¹ is attached to Z.

In some embodiments, L¹ is -G¹-.

In some embodiments, L² is absent.

In some embodiments:

L² is selected from -E¹-, -E¹-E²-, -E¹-E²-E³-, -E¹-E²-E³-E⁴-, -E¹-E²-E³-E⁴-E⁵-, and -E¹-E²-E³-E⁴-E⁵-E⁶-; and

E¹, E², E³, E⁴, E⁵, and E⁶ are each independently —C(R^{b})₂— or —¹³C(R^{b})₂—.

In some embodiments:

L² is -E¹-E²-; and

E¹ and E² are each independently —C(R^{b})₂— or —¹³C(R^{b})₂—.

In some embodiments:

L² is -E¹-E²-E³-; and

E¹, E², and E³ are each independently —C(R^{b})₂— or —¹³C(R^{b})₂—.

In some embodiments:

L² is -E¹-E²-E³-E⁴-E⁵-E⁶-; and

E¹, E², E³, E⁴, E⁵, and E⁶ are each independently —C(R^{b})₂— or —¹³C(R^{b})₂—.

In some embodiments, for the compound with the highest formula weight in the plurality:

C1, C2, C3, and C4 of the ring are each carbon-13;

X is ¹⁵N;

Y is ¹⁵N;

G¹ is —¹³C(R^{a})₂—; and

each R′ is D.

In some embodiments, for the compound with the highest formula weight in the plurality:

C1, C2, C3, and C4 of the ring are each carbon-13;

X is ¹⁵N;

Y is ¹⁵N;

G¹ is —¹³C(R^{a})₂—;

G² is —C(R^{a})₂—;

R^{a} is D;

R^{e} is D; and

each R′ is D.

In some embodiments, for the compound with the highest formula weight in the plurality:

C1, C2, C3, and C4 of the ring are each carbon-13;

X is ¹⁵N;

Y is ¹⁵N;

G¹ is —¹³CH₂—;

E² and E³ are each —¹³CH₂—;

E¹ is —¹³CD₂-; and

each R′ is D.

In some embodiments, for the compound with the highest formula weight in the plurality:

C1, C2, C3, and C4 of the ring are each carbon-13;

X is ¹⁵N;

Y is ¹⁵N;

G¹ is ¹³CD₂-,

E² is —¹³CH₂—;

E¹ is —¹³CD₂-; and

each R′ is D.

In some embodiments, for the compound with the highest formula weight in the plurality:

C1, C2, C3, and C4 of the ring are each carbon-13;

X is ¹⁵N;

Y is ¹⁵N;

G¹ is —¹³CD₂-;

each R′ is D; and

E¹, E², E³, E⁴, E⁵, and E⁶ are each —¹³CD₂-.

In some embodiments, the chemical tags are selected from a plurality of compounds of Formula III:

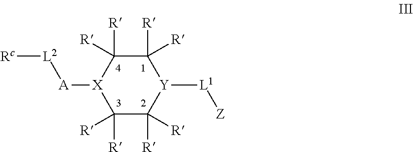

or salts thereof; wherein:

A is —N(R^{f})—, or —¹⁵N(R^{f})—;

X is selected from C(R′) and ¹³C(R′); and

Y is selected from C(R′) and ¹³C(R′).

In some embodiments, R¹ and R² are each H.

In some embodiments, Z is —C(═O)OH. In some embodiments, Z is —NH₂.

In some embodiments, L¹ is -G¹-G²-; wherein G¹ is attached to Z. In some embodiments, L¹ is -G¹-.

In some embodiments:

L² is -E¹-;

R^{f} is —F¹—R^{e};

E¹ is —C(R^{b})₂— or —¹³C(R^{b})₂—; and

F¹ is —C(R^{b′})₂— or —¹³C(R^{b})₂—.

In some embodiments, for the compound with the highest formula weight in the plurality:

C1, C2, C3, and C4 are each carbon-13;

X is ¹³C(R′);

Y is ¹³C(R′);

A is —¹⁵N(R^{f})—;

E¹ is —¹³CH₂—;

F¹ is —¹³CH₂—; and

G¹ is —¹³CD₂-.

In some embodiments, the chemical tags are selected from a plurality of compounds of Formula IV:

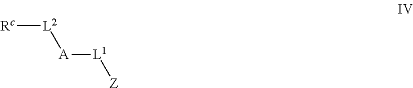

or salts thereof; wherein A is —N(R^{f})—, or —¹⁵N(R^{f})—.

In some embodiments, L¹ is —G¹-G²-.

In some embodiments:

L² is selected from -E¹-E²-E³-; wherein E¹ is attached to A;

R^{f} is selected from —F¹—F²—F³—R^{e};

E¹, E², and E³ are each independently —C(R^{b})₂— or —¹³C(R^{b})₂—; and

F¹, F², and F³ are each independently absent, —C(R^{b′})₂— or —¹³C(R^{b′})₂—.

In some embodiments, R¹ and R² are each H.

In some embodiments, Z is —C(═O)OH. In some embodiments, Z is —NH₂.

In some embodiments, for the compound with the highest formula weight in the plurality:

A is —¹⁵N(R¹)—;

E¹, E², and E³ are each —¹³CD₂-;

F¹, F², and F³ are each —¹³CD₂-; and

G¹ and G² are each —¹³CH₂—.

In some embodiments, the chemical tags are selected from a plurality of compounds of Formula VI:

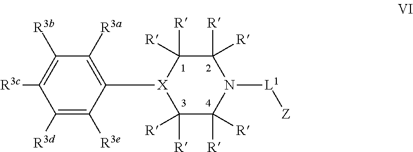

or salts thereof; comprising a non-isobaric series of compounds; wherein:

each compound in the series has the same structural formula but a different isotopic substitution pattern;

Z is selected from —C(═O)OR¹, —C(═O)X′, and —NHR²;

X¹ is halogen;

R¹ and R² are each independently selected from H and C₁₋₆ alkyl;

X is selected from C(R′), ¹³C(R′), N and ¹⁵N;

R^{3a}, R^{3b}, R^{3e}, R^{3d}, and R^{3e} are independently selected from H, D, and C₁₋₄ alkyl;

L¹ is -G¹-G²-G³-G⁴-G⁵-G⁶-; wherein G¹ is attached to Z;

G′ is —C(R^{a})₂— or —¹³C(R^{a})₂—;

G², G³, G⁴, G⁵, and G⁶ are each independently absent, —C(R^{a})₂—, or —¹³C(R^{a})₂—;

R^{a} is selected from H and D; and

C1, C2, C3, and C4 of the ring are independently carbon or carbon-13.

In some embodiments:

R^{3a}, R^{3b}, R^{3c}, R^{3d}, and R^{3e} are independently selected from H and D;

L¹ is -G¹-G²-;

G¹ and G² are each independently —C(R^{a})₂— or —¹³C(R^{a})₂—;

Z is —C(═O)OH or —NH₂; and

X is selected from C(R′) and ¹³C(R′).

In some embodiments, for at least some of compounds of the plurality, R^{a} is D. In some embodiments, for at least some of compounds of the plurality, R^{a} is D and the remaining variables are not isotopically substituted.

In some embodiments, R^{3a}, R^{3b}, R^{3e}, R^{3d}, and R^{3e} are independently selected from H and D.

In some embodiments, L¹ is -G′-G²-.

In some embodiments, G¹ and G² are each independently —C(R^{a})₂— or —¹³C(R^{a})₂—.

In some embodiments, Z is —C(═O)OH or —NH₂.

In some embodiments, X is selected from C(R′) and ¹³C(R′).

In some embodiments, the present invention provides a compound of Formula VI, or a salt thereof, as defined above, provided that the compound contains at least one atom selected from ¹³C, ¹⁵N, or D.

The following embodiments may apply to the previous embodiments for the compounds of Formulas I, II, III, and IV.

In some embodiments, L¹ is -G′-G²-; wherein G¹ is attached to Z. In some embodiments, L¹ is -G′-.

In some embodiments, one compound is not labeled with carbon-13, nitrogen-15 or D.

In some embodiments, the plurality comprises at least one compound, wherein G¹ is —¹³C(R^{a})₂—.

In some embodiments, the plurality comprises at least one compound labeled with carbon-13, nitrogen-15 or both as in any of the preceding embodiments, wherein:

X is ¹⁵N; and Y is ¹⁵N; or

X is ¹³C(R′); and Y is ¹³C(R′).

In some embodiments, the plurality comprises at least one compound labeled with carbon-13, nitrogen-15 or both as in any of the preceding embodiments, wherein A is −¹⁵NR^{f}—.

In some embodiments, the plurality comprises at least one compound labeled with carbon-13, nitrogen-15 or both as in any of the preceding embodiments, wherein G¹ and G² are each —¹³C(R^{b})₂—.

In some embodiments, the plurality comprises at least one compound labeled with carbon-13, nitrogen-15 or both as in any of the preceding embodiments, wherein G¹, G², and G³ are each —¹³C(R^{b})₂—.

In some embodiments, the plurality comprises at least one compound labeled with carbon-13, nitrogen-15 or both as in any of the preceding embodiments, wherein G¹, G², G³, and G⁴ are each —¹³C(R^{b})₂—.

In some embodiments, the plurality comprises at least one compound labeled with carbon-13, nitrogen-15 or both as in any of the preceding embodiments, wherein G¹, G², G³, G⁴, and G⁵ are each —¹³C(R^{b})₂—.

In some embodiments, the plurality comprises at least one compound labeled with carbon-13, nitrogen-15 or both as in any of the preceding embodiments, wherein G¹, G², G³, G⁴, G⁵, and G⁶ are each —¹³C(R^{b})₂—.

In some embodiments, the plurality comprises at least one compound labeled with carbon-13, nitrogen-15 or both as in any of the preceding embodiments, wherein C1 is carbon-13.

In some embodiments, the plurality comprises at least one compound labeled with carbon-13, nitrogen-15 or both as in any of the preceding embodiments, wherein C2 is carbon-13.

In some embodiments, the plurality comprises at least one compound labeled with carbon-13, nitrogen-15 or both as in any of the preceding embodiments, wherein C3 is carbon-13.

In some embodiments, the plurality comprises at least one compound labeled with carbon-13, nitrogen-15 or both as in any of the preceding embodiments, wherein C4 is carbon-13.

In some embodiments, the plurality comprises at least one compound labeled with carbon-13, nitrogen-15 or both as in any of the preceding embodiments, wherein C1 and C2 are each carbon-13.

In some embodiments, the plurality comprises at least one compound labeled with carbon-13, nitrogen-15 or both as in any of the preceding embodiments, wherein C1, C2, and C3 are each carbon-13.

In some embodiments, the plurality comprises at least one compound labeled with carbon-13, nitrogen-15 or both as in any of the preceding embodiments, wherein C1, C2, C3, and C4 are each carbon-13.

In some embodiments, the plurality comprises at least one compound labeled with carbon-13, nitrogen-15 or both as in any of the preceding embodiments, wherein E′ is —¹³C(R_{b})₂—.

In some embodiments, the plurality comprises at least one compound labeled with carbon-13, nitrogen-15 or both as in any of the preceding embodiments, wherein E¹ and E² are each —¹³C(R_{b})₂—.

In some embodiments, the plurality comprises at least one compound labeled with carbon-13, nitrogen-15 or both as in any of the preceding embodiments, wherein E′, E², and E³ are each —¹³C(R_{b})₂—.

In some embodiments, the plurality comprises at least one compound labeled with carbon-13, nitrogen-15 or both as in any of the preceding embodiments, wherein E′, E², E³, and E⁴ are each —¹³C(R_{b})₂—.

In some embodiments, the plurality comprises at least one compound labeled with carbon-13, nitrogen-15 or both as in any of the preceding embodiments, wherein E′, E², E³, E⁴, and E⁵ are each —¹³C(R_{b})₂—.

In some embodiments, the plurality comprises at least one compound labeled with carbon-13, nitrogen-15 or both as in any of the preceding embodiments, wherein E¹, E², E³, E⁴, E⁵, and E⁶ are each —¹³C(R_{b})₂—.

In some embodiments, the plurality comprises at least one compound labeled with carbon-13, nitrogen-15 or both as in any of the preceding embodiments, wherein E¹, E², E³, E⁴, E⁵, E⁶, and E⁷ are each —¹³C(R_{b})₂—.

In some embodiments, the plurality comprises at least one compound labeled with carbon-13, nitrogen-15 or both as in any of the preceding embodiments, wherein E¹, E², E³, E⁴, E⁵, E⁶, E⁷, and E⁸ are each —¹³C(R_{b})₂—.

In some embodiments, the plurality comprises at least one compound labeled with carbon-13, nitrogen-15 or both as in any of the preceding embodiments, wherein F¹ is —¹³C(R^{b′})₂—.

In some embodiments, the plurality comprises at least one compound labeled with carbon-13, nitrogen-15 or both as in any of the preceding embodiments, wherein F¹ and F² are each —¹³C(R^{b′})₂—.

In some embodiments, the plurality comprises at least one compound labeled with carbon-13, nitrogen-15 or both as in any of the preceding embodiments, wherein F¹, F², and F³ are each —¹³C(R^{b′})₂—.

In some embodiments, the plurality comprises at least one compound labeled with carbon-13, nitrogen-15 or both as in any of the preceding embodiments, wherein F¹, F², F³, and F⁴ are each —¹³C(R^{b′})₂—.

In some embodiments, the plurality comprises at least one compound labeled with carbon-13, nitrogen-15 or both as in any of the preceding embodiments, wherein F¹, F², F³, F⁴, and F⁵ are each —¹³C(R^{b′})₂—.

In some embodiments, the plurality comprises at least one compound labeled with carbon-13, nitrogen-15 or both as in any of the preceding embodiments, wherein F¹, F², F³, F⁴, F⁵, and F⁶ are each —¹³C(R^{b′})₂—.

In some embodiments, the plurality comprises at least one compound labeled with carbon-13, nitrogen-15 or both as in any of the preceding embodiments, wherein F¹, F², F³, F⁴, F⁵, F⁶, and F⁷ are each —¹³C(R^{b′})₂—.

In some embodiments, the plurality comprises at least one compound labeled with carbon-13, nitrogen-15 or both as in any of the preceding embodiments, wherein F¹, F², F³, F⁴, F⁵, F⁶, F⁷, and F⁸ are each —¹³C(R^{b′})₂—.

In some embodiments, the plurality comprises at least one compound labeled with carbon-13, nitrogen-15 or both as in any of the preceding embodiments and further having w D atoms wherein w is 1+(the total number of atoms labeled with carbon-13 or nitrogen-15 in the highest formula weight compound of the plurality which is not labeled with D).

In some embodiments, the plurality comprises at least one compound labeled with carbon-13, nitrogen-15 or both as in any of the preceding embodiments, wherein each R′ is D.

In some embodiments, the plurality comprises at least one compound labeled with carbon-13, nitrogen-15 or both as in any of the preceding embodiments, wherein G¹ is perdeuterated.

In some embodiments, the plurality comprises at least one compound labeled with carbon-13, nitrogen-15, deuterium, or combination thereof as in any of the preceding embodiments, wherein each R^{a} is D.

In some embodiments, the plurality comprises at least one compound labeled with carbon-13, nitrogen-15, deuterium, or combination thereof as in any of the preceding embodiments, wherein each R^{b} is D.

In some embodiments, the plurality comprises at least one compound labeled with carbon-13, nitrogen-15, deuterium, or combination thereof as in any of the preceding embodiments, wherein each R^{b′} is D.

For compounds in which a variable appears more than once, each variable can be a different moiety independently selected from the group defining the variable. For example, where a structure is described having two R groups that are simultaneously present on the same compound, the two R groups can represent different moieties independently selected from the group defined for R. In another example, when an optionally multiple substituent is designated in the form:

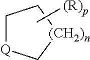

then it is understood that substituent R can occur p number of times on the ring, and R can be a different moiety at each occurrence. It is understood that each R group may replace any hydrogen atom attached to a ring atom, including one or both of the (CH₂)ₙ hydrogen atoms. Further, in the above example, should the variable Q be defined to include hydrogens, such as when Q is the to be CH₂, NH, etc., any floating substituent such as R in the above example, can replace a hydrogen of the Q variable as well as a hydrogen in any other non-variable component of the ring.

The compounds described herein can be asymmetric (e.g., having one or more stereocenters). All stereoisomers, such as enantiomers and diastereomers, are intended unless otherwise indicated. Compounds described herein that contain asymmetrically substituted carbon atoms can be isolated in optically active or racemic forms. Methods on how to prepare optically active forms from optically active starting materials are known in the art, such as by resolution of racemic mixtures or by stereoselective synthesis. Many geometric isomers of olefins, C═N double bonds, and the like can also be present in the compounds described herein, and all such stable isomers are contemplated in the present invention. Cis and trans geometric isomers of the compounds described herein may be isolated as a mixture of isomers or as separated isomeric forms. Where a compound capable of stereoisomerism or geometric isomerism is designated in its structure or name without reference to specific R/S or cis/trans configurations, it is intended that all such isomers are contemplated.

Resolution of racemic mixtures of compounds can be carried out by any of numerous methods known in the art. An example method includes fractional recrystallizaion using a chiral resolving acid which is an optically active, salt-forming organic acid. Suitable resolving agents for fractional recrystallization methods are, for example, optically active acids, such as the D and L forms of tartaric acid, diacetyltartaric acid, dibenzoyltartaric acid, mandelic acid, malic acid, lactic acid or the various optically active camphorsulfonic acids such as β-camphorsulfonic acid. Other resolving agents suitable for fractional crystallization methods include stereoisomerically pure forms of α-methylbenzylamine (e.g., S and R forms, or diastereomerically pure forms), 2-phenylglycinol, norephedrine, ephedrine, N-methylephedrine, cyclohexylethylamine, 1,2-diaminocyclohexane, and the like.

Resolution of racemic mixtures can also be carried out by elution on a column packed with an optically active resolving agent (e.g., dinitrobenzoylphenylglycine). Suitable elution solvent composition can be determined by one skilled in the art.

Compounds described herein also include tautomeric forms. Tautomeric forms result from the swapping of a single bond with an adjacent double bond together with the concomitant migration of a proton. Tautomeric forms include prototropic tautomers which are isomeric protonation states having the same empirical formula and total charge. Example prototropic tautomers include ketone enol pairs, amide—imidic acid pairs, lactam lactim pairs, amide—imidic acid pairs, enamine imine pairs, and annular forms where a proton can occupy two or more positions of a heterocyclic system, for example, 1H- and 3H-imidazole, 1H-, 2H- and 4H-1,2,4-triazole, 1H- and 2H-isoindole, and 1H and 2H-pyrazole. Tautomeric forms can be in equilibrium or sterically locked into one form by appropriate substitution.

Compounds described herein, or pharmaceutically acceptable salts or N-oxides thereof, further include hydrates and solvates, as well as anhydrous and non-solvated forms. Compounds described herein can also include all isotopes of atoms occurring in the intermediates or final compounds. Isotopes include those atoms having the same atomic number but different mass numbers. For example, isotopes of hydrogen include tritium and deuterium.

The term, “compound” as used herein is meant to include all stereoisomers, tautomers, and isotopes of the structures depicted.

As used herein, the phrase “optionally substituted” means unsubstituted or substituted. As used herein, the term “substituted” means that a hydrogen atom is removed and replaced by a substitutent. It is understood that substitution at a given atom is limited by valency.

As used herein, the term “Cₙ₋ₘ alkyl”, employed alone or in combination with other terms, refers to a saturated hydrocarbon group that may be straight-chain or branched, having n to m carbon atoms. In some embodiments, the alkyl group contains 1 to 12, 1 to 8, 1 to 6, or 1 to 4 carbon atoms. Examples of alkyl moieties include, but are not limited to, chemical groups such as methyl, ethyl, n-propyl, isopropyl, n-butyl, tert-butyl, isobutyl, sec-butyl, 2-methyl-1-butyl, n-pentyl, 3-pentyl, n-hexyl, 1,2,2-trimethylpropyl, n-heptyl, n-octyl, and the like.

As used herein, “Cₙ₋ₘ alkenyl”, employed alone or in combination with other terms, refers to an alkyl group having one or more double carbon-carbon bonds and n to m carbon atoms. In some embodiments, the alkenyl moiety contains 2 to 10 or 2 to 6 carbon atoms. Example alkenyl groups include, but are not limited to, ethenyl, n-propenyl, isopropenyl, n-butenyl, sec-butenyl, and the like.

As used herein, “Cₙ₋ₘ alkynyl”, employed alone or in combination with other terms, refers to an alkyl group having one or more triple carbon-carbon bonds, which may also optionally have one or more double carbon-carbon bonds, and having n to m carbon atoms. In some embodiments, the alkynyl moiety contains 2 to 10 or 2 to 6 carbon atoms. Example alkenyl groups include, but are not limited to, ethenyl, n-propenyl, isopropenyl, n-butenyl, sec-butenyl, and the like.

As used herein, the term “amine”, employed alone or in combination with other terms, refers to a group of formula —NH₂ or NHR, wherein R is C₁₋₆ alkyl.

As used herein, the term “cyano”, employed alone or in combination with other terms, refers to a group of formula —CN.

As used herein, the terms “halo” and “halogen”, employed alone or in combination with other terms, refer to fluoro, chloro, bromo, and iodo. In some embodiments, halogen is fluoro.

As used herein, the term “Cₙ₋ₘ haloalkyl”, employed alone or in combination with other terms, refers to an alkyl group having from n to m carbon atoms and one halogen atom to 2x+1 halogen atoms which may be the same or different, where “x” is the number of carbon atoms in the alkyl group. In some embodiments, the halogen atoms are fluoro atoms. In some embodiments, the alkyl group has 1 to 6 or 1 to 4 carbon atoms. An example of a haloalkyl group is —CF₃.

As used herein, “Cₙ₋ₘ haloalkoxy”, employed alone or in combination with other terms, refers to a group of formula —O-haloalkyl, wherein the haloalkyl group has n to m carbon atoms. In some embodiments, the alkyl group has 1 to 6 or 1 to 4 carbon atoms. An example haloalkoxy group is —OCF₃.

As used herein, the term “Cₙ₋ₘ fluorinated alkyl”, employed alone or in combination with other terms, refers to a haloalkyl wherein the halogen atoms are selected from fluorine. In some embodiments, fluorinated Cₙ, haloalkyl is fluoromethyl, difluoromethyl, or trifluoromethyl.

As used herein, the term “Cₙ₋ₘ cycloalkyl”, employed alone or in combination with other terms, refers to a non-aromatic cyclic hydrocarbon moiety, which may optionally contain one or more alkenylene groups as part of the ring structure, and which has n to m ring member carbon atoms. Cycloalkyl groups can include mono- or polycyclic (e.g., having 2, 3, or 4 fused, bridged, or spiro rings) ring systems. Also included in the definition of cycloalkyl are moieties that have one or more aromatic rings fused (i.e., having a bond in common with) to the cycloalkyl ring, for example, benzo derivatives of cyclopentane, cyclopentene, cyclohexane, and the like. The term “cycloalkyl” also includes bridgehead cycloalkyl groups and spirocycloalkyl groups. As used herein, “bridgehead cycloalkyl groups” refers to non-aromatic cyclic hydrocarbon moieties containing at least one bridgehead carbon, such as admantan-1-yl. As used herein, “spirocycloalkyl groups” refers to non-aromatic hydrocarbon moieties containing at least two rings fused at a single carbon atom, such as spiro[2.5]octane and the like. In some embodiments, the cycloalkyl group has 3 to 14 ring members, 3 to 10 ring members, or 3 to 7 ring members. In some embodiments, the cycloalkyl group is monocyclic or bicyclic. In some embodiments, the cycloalkyl group is monocyclic. In some embodiments, the cycloalkyl group is a C₃₋₇ monocyclic cycloalkyl group. One or more ring-forming carbon atoms of a cycloalkyl group can be oxidized to form carbonyl linkages. Example cycloalkyl groups include cyclopropyl, cyclobutyl, cyclopentyl, cyclohexyl, cycloheptyl, cyclopentenyl, cyclohexenyl, cyclohexadienyl, cycloheptatrienyl, norbornyl, norpinyl, norcarnyl, adamantyl, and the like. In some embodiments, the cycloalkyl group is admanatan-1-yl.

As used herein, the term “Cₙ₋ₘ cycloalkyl-Cₒ₋ₚ alkyl”, employed alone or in combination with other terms, refers to a group of formula -alkylene-cycloalkyl, wherein the cycloalkyl portion has n to m carbon atoms and the alkylene portion has o to p carbon atoms. In some embodiments, the alkylene portion has 1 to 4, 1 to 3, 1 to 2, or 1 carbon atom(s). In some embodiments, the alkylene portion is methylene. In some embodiments, the cycloalkyl portion has 3 to 14 ring members, 3 to 10 ring members, or 3 to 7 ring members. In some embodiments, the cycloalkyl group is monocyclic or bicyclic. In some embodiments, the cycloalkyl portion is monocyclic. In some embodiments, the cycloalkyl portion is a C₃₋₇ monocyclic cycloalkyl group.

As used herein, the term “Cₙ₋ₘ heterocycloalkyl”, “Cₙ₋ₘ heterocycloalkyl ring”, or “Cₙ₋ₘ heterocycloalkyl group”, employed alone or in combination with other terms, refers to non-aromatic ring or ring system, which may optionally contain one or more alkenylene or alkynylene groups as part of the ring structure, which has at least one heteroatom ring member independently selected from nitrogen, sulfur and oxygen, and which has n to m ring member carbon atoms. Heterocycloalkyl groups can include mono- or polycyclic (e.g., having 2, 3 or 4 fused, bridged, or spiro rings) ring systems. In some embodiments, the heterocycloalkyl group is a monocyclic or bicyclic group having 1, 2, 3, or 4 hetereoatoms independently selected from nitrogen, sulfur and oxygen. Also included in the definition of heterocycloalkyl are moieties that have one or more aromatic rings fused (i.e., having a bond in common with) to the non-aromatic ring, for example, 1,2,3,4-tetrahydro-quinoline and the like. Heterocycloalkyl groups can also include bridgehead heterocycloalkyl groups and spiroheterocycloalkyl groups. As used herein, “bridgehead heterocycloalkyl group” refers to a heterocycloalkyl moiety containing at least one bridgehead atom, such as azaadmantan-1-yl and the like. As used herein, “spiroheterocycloalkyl group” refers to a heterocycloalkyl moiety containing at least two rings fused at a single atom, such as [1,4-dioxa-8-aza-spiro[4.5]decan-N-yl] and the like. In some embodiments, the heterocycloalkyl group has 3 to 20 ring-forming atoms, 3 to 10 ring-forming atoms, or about 3 to 8 ring forming atoms. The carbon atoms or hetereoatoms in the ring(s) of the heterocycloalkyl group can be oxidized to form a carbonyl, or sulfonyl group (or other oxidized linkage) or a nitrogen atom can be quaternized. In some embodiments, the heterocycloalkyl portion is a C₂₋₇ monocyclic heterocycloalkyl group.

As used herein, the term “Cₙ₋ₘ heterocycloalkyl-Cₒ₋ₚ alkyl”, employed alone or in combination with other terms, refers to a group of formula -alkylene-heterocycloalkyl, wherein the heterocycloalkyl portion has n to m carbon atoms and the alkylene portion has o to p carbon atoms. In some embodiments, the alkylene portion has 1 to 4, 1 to 3, 1 to 2, or 1 carbon atom(s). In some embodiments, the alkylene portion is methylene. In some embodiments, the heterocycloalkyl portion has 3 to 14 ring members, 3 to 10 ring members, or 3 to 7 ring members. In some embodiments, the heterocycloalkyl group is monocyclic or bicyclic. In some embodiments, the heterocycloalkyl portion is monocyclic. In some embodiments, the heterocycloalkyl portion is a C₂₋₇ monocyclic heterocycloalkyl group.

As used herein, the term “Cₙ₋ₘ aryl”, employed alone or in combination with other terms, refers to a monocyclic or polycyclic (e.g., having 2, 3 or 4 fused rings) aromatic hydrocarbon moiety having n to m ring member carbon atoms, such as, but not limited to, phenyl, 1-naphthyl, 2-naphthyl, anthracenyl, phenanthrenyl, and the like. In some embodiments, aryl groups have from 6 to 14 carbon atoms, about 6 to 10 carbon atoms, or about 6 carbons atoms. In some embodiments, the aryl group is a monocyclic or bicyclic group.

As used herein, the term “Cₙ₋ₘ aryl-Cₒ₋ₚ-alkyl”, employed alone or in combination with other terms, refers to a group of formula -alkylene-aryl, wherein the aryl portion has n to m ring member carbon atoms and the alkylene portion has o to p carbon atoms. In some embodiments, the alkylene portion has 1 to 4, 1 to 3, 1 to 2, or 1 carbon atom(s). In some embodiments, the alkylene portion is methylene. In some embodiments, the aryl portion is phenyl. In some embodiments, the aryl group is a monocyclic or bicyclic group. In some embodiments, the arylalkyl group is benzyl.

As used herein, the term “Cₙ₋ₘ heteroaryl”, “Cₙ₋ₘ heteroaryl ring”, or “Cₙ₋ₘ heteroaryl group”, employed alone or in combination with other terms, refers to a monocyclic or polycyclic (e.g., having 2, 3 or 4 fused rings) aromatic hydrocarbon moiety, having one or more heteroatom ring members independently selected from nitrogen, sulfur and oxygen and having n to m ring member carbon atoms. In some embodiments, the heteroaryl group is a monocyclic or bicyclic group having 1, 2, 3, or 4 hetereoatoms independently selected from nitrogen, sulfur and oxygen. Example heteroaryl groups include, but are not limited to, pyrrolyl, azolyl, oxazolyl, thiazolyl, imidazolyl, furyl, thienyl, quinolinyl, isoquinolinyl, indolyl, benzothienyl, benzofuranyl, benzisoxazolyl, imidazo[1,2-b]thiazolyl or the like. The carbon atoms or hetereoatoms in the ring(s) of the heteroaryl group can be oxidized to form a carbonyl, or sulfonyl group (or other oxidized linkage) or a nitrogen atom can be quaternized, provided the aromatic nature of the ring is preserved. In some embodiments, the heteroaryl group has 5 to 10 carbon atoms.

As used herein, the term “Cₙ₋ₘ heteroaryl-Cₒ₋ₚ-alkyl”, employed alone or in combination with other terms, refers to a group of formula -alkylene-heteroaryl, wherein the heteroaryl portion has n to m ring member carbon atoms and the alkylene portion has to p carbon atoms. In some embodiments, the alkylene portion has 1 to 4, 1 to 3, 1 to 2, or 1 carbon atom(s). In some embodiments, the alkylene portion is methylene. In some embodiments, the heteroaryl portion is a monocyclic or bicyclic group having 1, 2, 3, or 4 hetereoatoms independently selected from nitrogen, sulfur and oxygen. In some embodiments, the heteroaryl portion has 5 to 10 carbon atoms.

The term “protecting group” with respect to R² includes the protecting groups for amines described in Greene, et al., Protective Groups in Organic Synthesis, 4d. Ed., Wiley & Sons, 2007, which is incorporated herein by reference in its entirety.

Unless otherwise indicated herein, the point of attachment of a substituent is generally in the last portion of the name (e.g., arylalkyl is attached through the alkylene portion of the group).

### EXAMPLES OF THE DIAGNOSTIC TECHNIQUES

### Methodology

### Protocol.

Stable isotopically labeled glucose (6,6-d₂-D-glucose) (1-2 grams) is mixed with regular glucose to make up a dose of 75 grams in total. The glucose mixture is then given to the individual as in a conventional OGTT method. Blood samples are collected at 7 times—at 0 (immediately before the oral dosing), 30, 60, 90, 120, 150 and 180 minutes after oral dosage. Glucose is purified from the samples and then analyzed by GC-MS or LC-MS. Glucose concentration can also be measured using other means such as a enzymatic glucose analyzer as usually done with conventional OGTT.

Alternatively, each derivatized by a unique chemical tag (i.e. differed by mass only) and analyzed by GC-MS or LC-MS to determine glucose concentration and isotope enrichment.

The determined glucose isotope enrichment for each time point is used to calculate the amount of blood glucose (mmol/l) that originates from the oral glucose at that time. The difference between this amount of orally derived glucose and the total blood glucose concentration (mmol/l) is the amount of endogenously produced glucose at that time point. The orally derived glucose and endogenously produced glucose are integrated across the duration of OGTT (0-180 min). These two amounts can be expressed, for instance, as the area under curve of orally derived glucose (AUC_{muscle}) and endogenously produced glucose (AUCₗᵢᵥₑᵣ)

### Calculation.

AUCₗᵢᵥₑᵣ and AUC_{muscle} from a patient are compared with the corresponding AUCs from a group of healthy individuals as testing reference (patient AUC/average AUC for a control group of healthy individuals). These healthy individuals (n=5) are lean and normoglycemic without known metabolic diseases or other major medical conditions. In doing so, a ratio is derived for both liver and muscle of the patient, termed glucose intolerance index (GII):

GII=patient AUC/reference AUC Equation 1.

The resulting GIIₗᵢᵥₑᵣ and GII_{muscle} are used for subtyping (organ specificity) of glucose intolerance.

### Subtyping.

By applying Equation 1 to the reference group itself, an average GIIₗᵢᵥₑᵣ of 1.00±0.23 and an average GII_{muscle} of 1.00±0.12 (mean±SD, wherein SD is standard deviation) are derived for the group. The standard deviations are used for subtyping of glucose intolerance in each patient using the 3×SD rules as follows.

The degree of impairment in EGP suppression in a patient is quantified by the difference between his/her GIIₗᵢᵥₑᵣ value and the average GIIₗᵢᵥₑᵣ of the reference group, termed ΔGIIₗᵢᵥₑᵣ (ΔGIIₗᵢᵥₑᵣ=patient GIIₗᵢᵥₑᵣ−1.00). ΔGIIₗᵢᵥₑᵣ is then compared to the standard deviation of GIIₗᵢᵥₑᵣ for the reference group: ΔGIIₗᵢᵥₑᵣ/0.23. If ΔGIIₗᵢᵥₑᵣ is greater than 0.68 (3×SD), the patient is categorized as liver type.

ΔGII_{muscle} is calculated in a similar way for each patient. Then ΔGII_{muscle} is compared to the standard deviation of GII_{muscle} for the reference group: ΔGII_{muscle}/0.12. If ΔGII_{muscle} is greater than 0.36 (3×SD), then the patient is categorized as muscle type. If a patient meets both these criteria, the patient is categorized as mixed type.

In theory, the application of the 3×SD rules detect patients with liver type or/and muscle type of glucose intolerance with 1% chance for false positive results. Therefore, once identified as liver type or muscle type, a patient is certain to be impaired in the functions of glucose metabolism in the liver or/and in peripheral tissues, respectively. Since skeletal muscle is responsible for >80% of insulin-mediated glucose uptake, peripheral problem is usually a muscle problem.

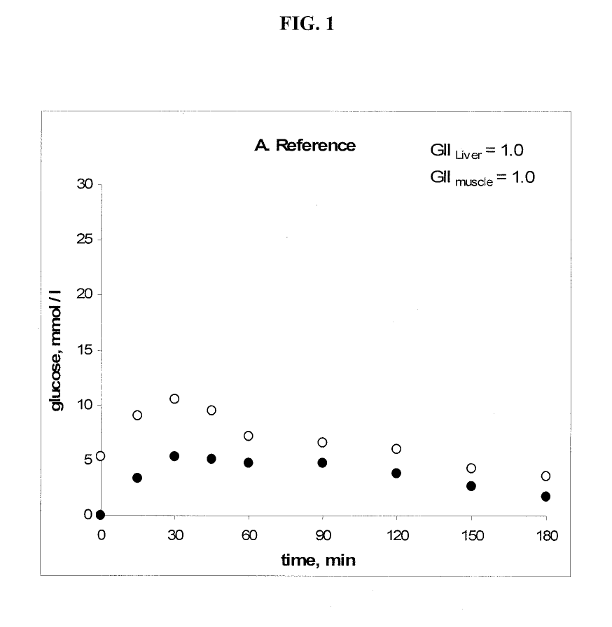

FIG. 1-4 each shows the results for a representative patient from the reference group, a liver type, a muscle type and a mixed type. The concentrations (mmol/l) of total plasma glucose (open circles) and plasma glucose coming from oral glucose (solid circles) at each time point during OGTT from the four individuals, each representing the healthy reference group (A), liver type of glucose intolerance (B), muscle type of glucose intolerance (C) and mixed type of glucose intolerance (D). The area under curve (AUC) of the oral glucose in plasma is calculated to reflect glucose uptake by skeletal muscle (1/AUC_{muscle}). AUC_{muscle} is in an inverse relationship with the extent of glucose uptake, that is, the smaller an AUC_{muscle} value is, the more glucose is taken up. And vice versa. The vertical distance between the oral glucose and the total plasma glucose concentration at each time point (i.e. [symbol] ◯) is the concentration of endogenously produced glucose mainly from the liver. Thus, the integrated area for this distance over the period of 0-180 min (AUCₗᵢᵥₑᵣ) represents endogenous glucose production during OGTT. AUCₗᵢᵥₑᵣ is proportional to EGP, that is, a small AUCₗᵢᵥₑᵣ indicates low EGP (i.e. effective suppression of EGP), and vice versa. GIIₗᵢᵥₑᵣ and GII_{muscle} are then calculated (Equation 1). GIIₗᵢᵥₑᵣ and GII_{muscle} proportionately reflect the degree of impairment in the suppression of EGP and the degree of impairment in glucose uptake, respectively. Note that in these particular OGTT experiments, 2 additional time points were used for blood sampling (15 and 45 min). Statistical comparisons indicated that the results are the same if these 2 time points are ignored in calculations. Thus, in future OGTT, these 2 time points are unnecessary and the other 7 time points at 30 min intervals are appropriate.

FIG. 1—Reference group: this figure shows the results for a representative healthy individual from the reference group. Both GIIₗᵢᵥₑᵣ and GII_{muscle} are equal to 1.0, indicating low EGP and prompt glucose uptake during OGTT, as expected of healthy individuals.

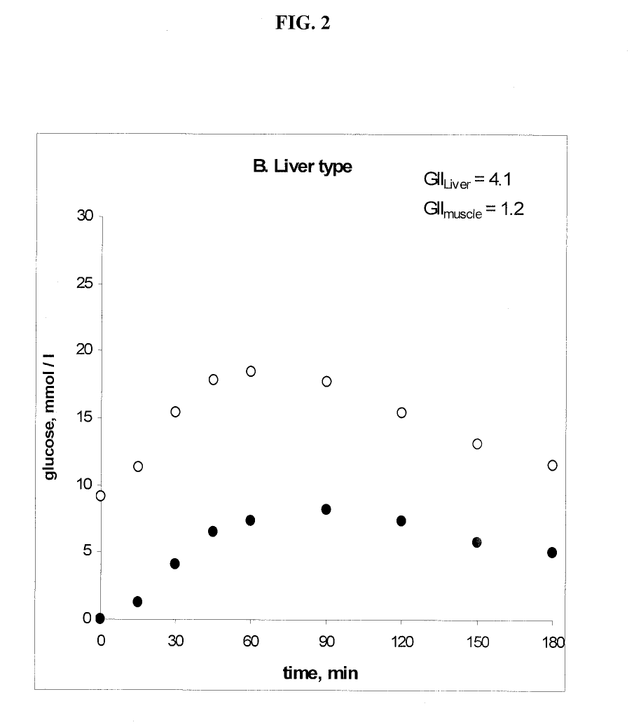

FIG. 2—Liver type: figure shows the results for a patient with type 2 diabetes. GII_{muscle} is 1.2 and thus ΔGII_{muscle}=0.2 (<0.36). Based on the 3×SD rule, the patient is considered not different from the reference group in terms of peripheral glucose uptake. By comparison, the GIIₗᵢᵥₑᵣ is 4.1 and thus ΔGIIₗᵢᵥₑᵣ=3.1 (>0.69). Therefore, based on the 3×SD rule, the patient is categorized as liver type of glucose intolerance.

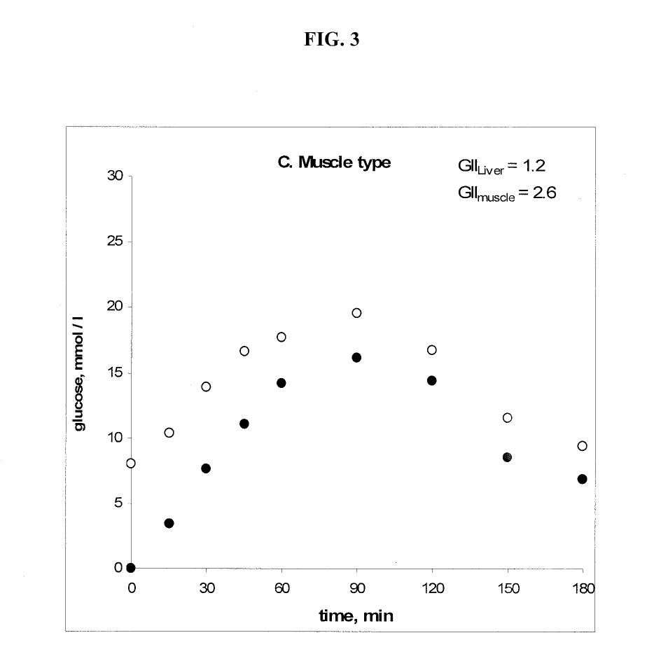

FIG. 3—Muscle type: figure shows the results from a patient with type 2 diabetes. GIIₗᵢᵥₑᵣ is 1.2 and thus ΔGIIₗᵢᵥₑᵣ=0.2 (<0.69). Therefore, the patient is considered not different from the reference group in terms of EGP. In contrast, GII_{muscle} is 2.6. Thus ΔGII_{muscle}=1.6 (>0.36). Therefore, based on the 3×SD rule the patient is categorized as muscle type of glucose intolerance.

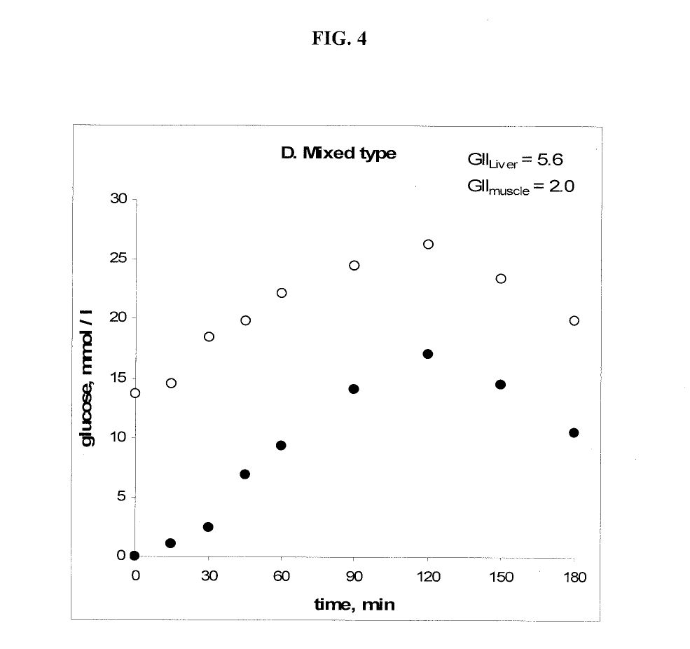

FIG. 4—Mixed type: the figure shows results from a patient with severe diabetes. GIIₗᵢᵥₑᵣ is 5.6 and GII_{muscle} is 2.0. Thus, ΔGIIₗᵢᵥₑᵣ=4.6>0.69 (3×SD), and ΔGII_{muscle}=1.0>0.36 (3×SD). As the patient meets the criteria for both liver type and muscle type, the patient is categorized as mixed type of glucose intolerance.

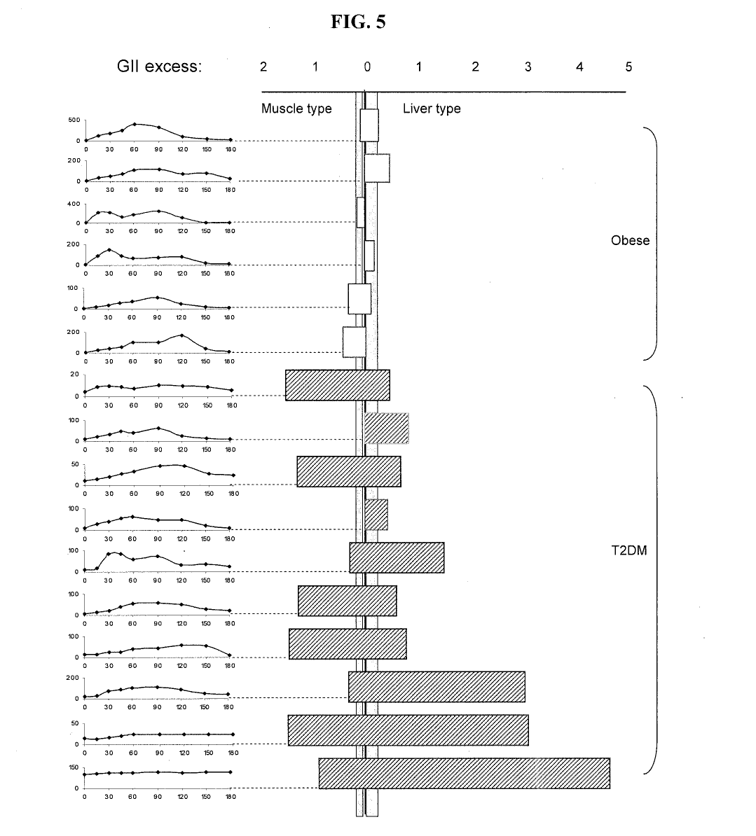

Clinical Subtyping of Patients with Glucose Intolerance or Hyperglycemia (FIG. 5).

Glucose intolerance index (GII) at the top panel, as determined using the described isotope-assisted OGTT technique (iOGTT), is a measure of glucose metabolic functions in skeletal muscle (glucose uptake) or liver (hepatic glucose production). In order to identify and quantify impairments in these functions, a patient's GII is compared to a healthy control group to derive a parameter termed GII excess (GII excess=GIIₚₐₜᵢₑₙₜ GII_{control} group). GII excess here is the same as ΔGII discussed in the text above (i.e. GII excess=ΔGII). GII excess=0 (the middle bold vertical line) represents normality of liver and muscle functions in the healthy control group (GII_{control}−GII_{control}). The grey bars flanking the normality line is the variability of liver (SD=0.23) or muscle functions (SD=0.12) for the control group (standard deviation, SD). A value of GII excess greater than 3×SD indicates impairment in muscle (left, i.e. impaired glucose uptake) or liver (right, i.e. impaired suppression of hepatic glucose production). Each horizontal bar represents a patient who participated in this study.

The obese patients (n=6) all had small GII excess around the normality line and are not statistically different from the control group (P>0.1). However, two of them had impaired glucose tolerance (second and sixth obese patients). Based on the direction of the bars, it can be seen that the minor impairment was in the liver for one patient and in muscle for the other patient. None of the obese participants met the 3×SD criteria. Therefore, they are not liver type nor muscle type of glucose intolerance. In contrast, 8 of the 10 diabetes patients met the 3×SD criteria and were thus subtyped as muscle type (first, third, sixth and seventh diabetes patients), liver type (fifth and eighth diabetes patients) or mixed type (ninth and tenth diabetes patients). Mixed type means both liver and muscle are impaired. The other two diabetes patients had recovered by taking medications. One of them (fourth diabetes patient) had achieved normal glycemia (no impaired fasting glucose or impaired glucose tolerance) but with slight impairment in the liver similar in degree to that seen in obese patients (GII excess<3×SD). The other patient (second diabetes patient) remained modestly impaired in the liver (GII excess=3×SD).

The left panel shows plasma insulin profile in each of the patients recorded at the same time as above. This information isn't required for the subtyping of liver and muscle per se as described above, but provided here only for patient evaluation purpose. By inspection of liver and muscle functions shown on the right and the corresponding insulin profile at the left, the internal organs with impaired functions in each patient become clearer than with the conventional OGTT, which only measures plasma glucose concentration and thus unable to probe organ-specific impairment. For instance, the fifth diabetes patient had strong insulin response as expected after the glucose drink with a peak at 30 min, indicating that the problem was not insulin, but due to impaired suppression of hepatic glucose production (GII excess=1.5). But the muscle function was nearly normal. By comparison, the tenth diabetes patient (bar at the bottom) had constant hyperinsulinemia and did not respond to the glucose drink at all (flat insulin curve). Hepatic glucose production was little suppressed (GU excess=4.7) but glucose uptake was close to normal. This suggests that the patient had impaired insulin response and severe insulin resistance in the liver. The organ location of glucose intolerance in the other patients can be evaluated similarly.

The knowledge of plasma insulin level and profile can allow the doctor to diagnose a patient to determine whether his/her insulin secretion is normal or impaired, and whether his/her plasma insulin level is adequate or deficient. Based on the diagnostic results on insulin, the doctor may decide to use therapy suited for the patient. If the patient is insulin-deficient or/and impaired in insulin response, insulin or other insulin secretagogues may be prescribed. Such abnormalities of insulin may be separate entities of diseases from liver type glucose intolerance, skeletal muscle glucose intolerance or mixed glucose intolerance. For instance, the diagnosed liver or muscle problems may be secondary to insulin deficiency. In such instances, insulin or insulin secretagogue are the choice of therapy. If insulin level or insulin response are normal, then the diagnosed glucose intolerance is due to liver glucose intolerance, skeletal muscle glucose intolerance or mixed glucose intolerance. In these instances, therapies targeting liver or/and skeletal muscle are the choice of therapy.

Therefore, by using iOGTT, the loci of glucose metabolism impairment in each patient can be clinically determined and quantified. By doing so, there are two advantages. First, the information enables the doctor to select the appropriate medications to target the impaired organs. Secondly, the dosages of medications can be titrated according to the degree of impairment so that hypoglycemia can be reduced or avoided which is often seen clinically in the current glycemic control regimens.

To date, organ-specific glucose metabolism has been possible only through research using complicated techniques that are not applicable to the clinical environment. The application of iOGTT will open up such possibilities. In addition to diabetes and obesity, and pre-diabetes, the same can be done with other populations with increased risk for type 2 diabetes. This includes obese or overweight individuals and the elderly with normoglycemia or without increased blood glucose level. In other words, the technique applicability of iOGTT is independent of glucose concentration. As long as level. Individuals with normal glucose level but already have mild impairment exists in the liver or muscle, I organs can be detected or diagnosed using iOGTT to identify the abnormal organs. This capability enables diabetes prevention measures to one to discover early stage impairment in glucose metabolism so that interventions can be taken or initiated as early as possible to prevent the worsening of the impairment, and thus the development into type 2 diabetes can be stopped.

What is claimed is:

1. A method of diagnosing organ specificity of glucose intolerance in an individual, comprising:
determining total plasma glucose concentration and plasma glucose concentration coming from orally administered glucose for a plurality of blood samples collected from an individual, wherein the blood samples were collected from the individual at different time intervals after oral administration of a mixture comprising isotopically labeled glucose and unlabeled glucose;
determining total plasma glucose concentration for a blood sample collected from the individual before the oral administration;
calculating AUC_{muscle} for the individual, wherein AUC_{muscle} is the area-under-the-curve for a plot of the plasma glucose concentration coming from orally administered glucose (y-axis) versus time elapsed since the oral administration of the mixture (x-axis) for the plurality of blood samples;
calculating AUCₗᵢᵥₑᵣ for the individual, wherein AUCₗᵢᵥₑᵣ=AUCₜₒₜₐₗ−AUC_{muscle}, wherein AUCₜₒₜₐₗ is the area-under-the-curve for a plot of the total plasma glucose concentration (y-axis) versus time elapsed since the oral administration of the mixture (x-axis) for the plurality of blood samples;
diagnosing the individual as having liver type glucose intolerance, muscle type glucose intolerance, or mixed type glucose intolerance, wherein:
the individual has liver type glucose intolerance if the AUCₗᵢᵥₑᵣ for the individual is significantly greater than the average AUCₗᵢᵥₑᵣ for a control group of healthy individuals; and the AUC_{muscle} for the individual is not significantly greater than an average AUC_{muscle} for a control group of healthy individuals;
the individual has muscle type glucose intolerance if the AUC_{muscle} for the individual is significantly greater than the average AUC_{muscle} for the control group of healthy individuals, but the AUCₗᵢᵥₑᵣ for the individual is not significantly greater than the average AUCₗᵢᵥₑᵣ for the control group of healthy individuals; and
the individual has mixed type glucose intolerance if the AUCₗᵢᵥₑᵣ for the individual is significantly greater than the average AUCₗᵢᵥₑᵣ for the control group of healthy individuals; and the AUC_{muscle} for the individual is significantly greater than the average AUC_{muscle} for the control group of healthy individuals.

2. A method according to claim 1, wherein the method comprises:
administering a mixture comprising isotopically labeled glucose and unlabeled glucose to an individual;
collecting a plurality of blood samples at different time intervals after the administering;
collecting a blood sample from the individual before the administering;
determining total plasma glucose concentration and plasma glucose concentration coming from orally administered glucose for the plurality of blood samples collected from the individual;
determining total plasma glucose concentration for the blood sample collected from the individual before the administering;
calculating AUC_{muscle} for the individual, wherein AUC_{muscle} is the area-under-the-curve for a plot of the plasma glucose concentration coming from orally administered glucose (y-axis) versus time elapsed since the oral administration of the mixture (x-axis) for the plurality of blood samples;
calculating AUCₗᵢᵥₑᵣ for the individual, wherein AUCₗᵢᵥₑᵣ=AUCₜₒₜₐₗ−AUC_{muscle}, wherein AUCₜₒₜₐₗ is the area-under-the-curve for a plot of the total plasma glucose concentration (y-axis) versus time elapsed since the oral administration of the mixture (x-axis) for the plurality of blood samples;
diagnosing the individual as having liver type glucose intolerance, muscle type glucose intolerance, or mixed type glucose intolerance, wherein:
the individual has liver type glucose intolerance if the AUCₗᵢᵥₑᵣ for the individual is significantly greater than an average AUCₗᵢᵥₑᵣ for a control group of healthy individuals; and the AUC_{muscle} for the individual is significantly greater than an average AUC_{muscle} for a control group of healthy individuals;
the individual has muscle type glucose intolerance if the AUC_{muscle} for the individual is significantly greater than the average AUC_{muscle} for the control group of healthy individuals, but the AUCₗᵢᵥₑᵣ for the individual is not significantly greater than the average AUCₗᵢᵥₑᵣ for the control group of healthy individuals; and
the individual has mixed type glucose intolerance if the AUCₗᵢᵥₑᵣ for the individual is significantly greater than the average AUCₗᵢᵥₑᵣ for the control group of healthy individuals; and the AUC_{muscle} for the individual is significantly greater than the average AUC_{muscle} for the control group of healthy individuals.

3. A method of diagnosing organ specificity of glucose intolerance in an individual, comprising:
determining total plasma glucose concentration and plasma glucose concentration coming from orally administered glucose for a plurality of blood samples collected from an individual, wherein the blood samples were collected from the individual at different time intervals after oral administration of a mixture comprising isotopically labeled glucose and unlabeled glucose;
determining total plasma glucose concentration for a blood sample collected from the individual before the oral administration;
calculating AUC_{muscle} for the individual, wherein AUC_{muscle} is the area-under-the-curve for a plot of the plasma glucose concentration coming from orally administered glucose (y-axis) versus time elapsed since the oral administration of the mixture (x-axis) for the plurality of blood samples;
calculating AUCₗᵢᵥₑᵣ for the individual, wherein AUCₗᵢᵥₑᵣ=AUCₜₒₜₐₗ−AUC_{muscle}, wherein AUCₜₒₜₐₗ is the area-under-the-curve for a plot of the total plasma glucose concentration (y-axis) versus time elapsed since the oral administration of the mixture (x-axis) for the plurality of blood samples;
calculating GII_{muscle} (skeletal muscle glucose intolerance index) for the individual by dividing the AUC_{muscle} for the individual by an average AUC_{muscle} for a control group of healthy individuals;
calculating GIIₗᵢᵥₑᵣ (heptatic glucose intolerance index) for the individual by dividing the AUCₗᵢᵥₑᵣ for the individual by an average AUCₗᵢᵥₑᵣ for the control group of healthy individuals;
calculating ΔGII_{muscle}, wherein ΔGII_{muscle}=GII_{muscle}−1.0;
calculating ΔGIIₗᵢᵥₑᵣ, wherein ΔGIIₗᵢᵥₑᵣ=GIIₗᵢᵥₑᵣ−1.0;
diagnosing the individual as having liver type glucose intolerance, muscle type glucose intolerance, or mixed type glucose intolerance, wherein:
the individual has liver type glucose intolerance if the ΔGIIₗᵢᵥₑᵣ for the individual is at least 3 times the standard deviation for an average GIIₗᵢᵥₑᵣ for the control group of healthy individuals; and the ΔGII_{muscle} for the individual is less than 3 times the standard deviation for an average GII_{muscle} for the control group of healthy individuals;
the individual has muscle type glucose intolerance if the ΔGII_{muscle} for the individual is at least 3 times the standard deviation for an average GII_{muscle} for a control group of healthy individuals, but the ΔGIIₗᵢᵥₑᵣ for the individual is less than 3 times the standard deviation for the average GIIₗᵢᵥₑᵣ for the control group of healthy individuals; and
the individual has mixed type glucose intolerance if the ΔGIIₗᵢᵥₑᵣ for the individual is at least 3 times the standard deviation for the average GIIₗᵢᵥₑᵣ for the control group of healthy individuals; and the ΔGII_{muscle} for the individual is at least 3 times the standard deviation for the average GII_{muscle} for the control group of healthy individuals.

4. A method according to claim 3, wherein the method comprises:
administering a mixture comprising isotopically labeled glucose and unlabeled glucose to an individual;
collecting a plurality of blood samples at different time intervals after the administering;
collecting a blood sample from the individual before the administering;
determining total plasma glucose concentration and plasma glucose concentration coming from orally administered glucose for the plurality of blood samples collected from the individual;
determining total plasma glucose concentration for the blood sample collected from the individual before the administering;
calculating AUC_{muscle} for the individual, wherein AUC_{muscle} is the area-under-the-curve for a plot of the plasma glucose concentration coming from orally administered glucose (y-axis) versus time elapsed since the oral administration of the mixture (x-axis) for the plurality of blood samples;
calculating AUCₗᵢᵥₑᵣ for the individual, wherein AUCₗᵢᵥₑᵣ=AUCₜₒₜₐₗ−AUC_{muscle}, wherein AUCₜₒₜₐₗ is the area-under-the-curve for a plot of the total plasma glucose concentration (y-axis) versus time elapsed since the oral administration of the mixture (x-axis) for the plurality of blood samples;
calculating GII_{muscle} (skeletal muscle glucose intolerance index) for the individual by dividing AUC_{muscle} for the individual by an average AUC_{muscle} for a control group of healthy individuals;
calculating GIIₗᵢᵥₑᵣ (heptatic glucose intolerance index) for the individual by dividing AUCₗᵢᵥₑᵣ for the individual by an average AUCₗᵢᵥₑᵣ for a control group of healthy individuals;
calculating ΔGII_{muscle}, wherein ΔGII_{muscle}=GII_{muscle}−1.0;
calculating ΔGIIₗᵢᵥₑᵣ, wherein ΔGIIₗᵢᵥₑᵣ=GIIₗᵢᵥₑᵣ−1.0;
diagnosing the individual as having liver type glucose intolerance, muscle type glucose intolerance, or mixed type glucose intolerance, wherein:
the individual has liver type glucose intolerance if the ΔGIIₗᵢᵥₑᵣ for the individual is at least 3 times the standard deviation for an average GIIₗᵢᵥₑᵣ for the control group of healthy individuals; and the ΔGII_{muscle} for the individual is less than 3 times the standard deviation for an average GII_{muscle} for the control group of healthy individuals;
the individual has muscle type glucose intolerance if the ΔGII_{muscle} for the individual is at least 3 times the standard deviation for an average GII_{muscle} for a control group of healthy individuals, but the ΔGIIₗᵢᵥₑᵣ for the individual is less than 3 times the standard deviation for the average GIIₗᵢᵥₑᵣ for the control group of healthy individuals; and
the individual has mixed type glucose intolerance if the ΔGIIₗᵢᵥₑᵣ for the individual is at least 3 times the standard deviation for the average GIIₗᵢᵥₑᵣ for the control group of healthy individuals; and the ΔGII_{muscle} for the individual is at least 3 times the standard deviation for the average GII_{muscle} for the control group of healthy individuals.

5. The method according to claim 4, further comprising treating the individual with a therapy suited to muscle type glucose intolerance if the individual is diagnosed as having muscle type glucose intolerance; or treating the individual with a therapy suited to liver type glucose intolerance if the individual is diagnosed as having liver type glucose intolerance; or treating the individual with a therapy suited to mixed type glucose intolerance if the individual is diagnosed as having mixed type glucose intolerance.

6. The method according to claim 4, further comprising determining plasma insulin concentration for the plurality of blood samples collected from the individual; determining plasma insulin concentration for the blood sample collected from the individual before the oral administration; and determining whether the plasma insulin concentration versus time profile is normal or abnormal.

7. The method according to claim 6, further comprising treating the individual with a therapy suited to insulin deficiency if the plasma insulin concentration versus time profile is abnormal compared to the insulin profile for a healthy individual; or treating the individual with a therapy suited to muscle type glucose intolerance if the individual is diagnosed as having muscle type glucose intolerance and the plasma insulin concentration versus time profile is normal; or treating the individual with a therapy suited to liver type glucose intolerance if the individual is diagnosed as having liver type glucose intolerance and the plasma insulin concentration versus time profile is normal; or treating the individual with a therapy suited to mixed type glucose intolerance if the individual is diagnosed as having mixed type glucose intolerance and the plasma insulin concentration versus time profile is normal.

8. The method according to claim 4, wherein the isotopically labeled glucose is 6,6-d₂-D-glucose.

9. The method according to claim 4, wherein the mixture comprises 1% to 3% (w/w) isotopically labeled glucose based on the total weight of labeled and unlabeled glucose.

10. The method according to claim 4, wherein the mixture comprises 1% to 3% (w/w) 6,6-d₂-D-glucose based on the total weight of labeled and unlabeled glucose.

11. The method according to claim 10, wherein the blood samples are collected over at least a two hour period after the oral administration.

12. The method according to claim 10, wherein the blood samples are collected over at least a three hour period after the oral administration.

13. The method according to claim 10, wherein the blood samples are collected at about 30 minutes, about 60 minutes, about 90 minutes, about 120 minutes, about 150 minutes, and about 180 minutes after the oral administration of the mixture.

14. The method according to claim 10, wherein the blood sample collected before the oral administration is collected within 15 minutes of the oral administration.

15. The method according to claim 10, wherein the total plasma glucose concentration is measured by using a glucose analyzer for each blood sample.

16. The method according to claim 4, wherein the plasma glucose concentration coming from orally administered glucose for each blood sample is determined by a method comprising:
measuring the molecular ion peak area for the isotopically labeled glucose (PA_{tracer-sample}) and the molecular ion peak area for unlabeled glucose (PA_{tracee-sample}) by liquid chromatography-mass spectrometry or gas chromatography-mass spectrometry for each blood sample;
calculating molar percent excess for each blood sample (MPEₛₐₘₚₗₑ) by dividing PA_{tracer-sample} by the sum of PA_{tracer-sample} and PA_{tracee-sample} for the blood sample;
measuring the molecular ion peak area for isotopically labeled glucose in the mixture (PA_{tracer-mixture}) and the molecular ion peak area for unlabeled glucose in the mixture (PA_{tracee-mixture}) by liquid chromatography-mass spectrometry or gas chromatography-mass spectrometry;
calculating molar percent excess for the mixture (MPEₘᵢₓₜᵤᵣₑ) by dividing PA_{tracer-mixture} by the sum of PA_{tracer-mixture} and PA_{tracee-mixture};
calculating the plasma glucose concentration coming from orally administered glucose for each blood sample by multiplying the total plasma glucose concentration for the blood sample by the ratio of MPEₛₐₘₚₗₑ/MPEₘᵢₓₜᵤᵣₑ for the blood sample.

17. The method according to claim 4, wherein the average AUC_{muscle} and the average AUCₗᵢᵥₑᵣ for the control group of healthy individuals is measured by a method comprising:
determining total plasma glucose concentration and plasma glucose concentration coming from orally administered glucose for a plurality of blood samples collected from a healthy individual, wherein the blood samples were collected from the healthy individual at different time intervals after oral administration of a mixture comprising isotopically labeled glucose and unlabeled glucose;
determining total plasma glucose concentration for a blood sample collected from the healthy individual before the oral administration;
calculating AUC_{muscle} for the healthy individual, wherein AUC_{muscle} is the area-under-the-curve for a plot of the plasma glucose concentration coming from orally administered glucose (y-axis) versus time elapsed since the oral administration of the mixture (x-axis) for the plurality of blood samples;
calculating AUCₗᵢᵥₑᵣ for the healthy individual, wherein AUCₗᵢᵥₑᵣ=AUCₜₒₜₐₗ−AUC_{muscle}, wherein AUCₜₒₜₐₗ the area-under-the-curve for a plot of the total plasma glucose concentration (y-axis) versus time elapsed since the oral administration of the mixture (x-axis) for the plurality of blood samples;
repeating the previous steps for additional individual in the healthy control group; and
averaging AUC_{muscle} and AUCₗᵢᵥₑᵣ for the control group of healthy individuals to obtain the average AUC_{muscle} for the control group of healthy individuals and the average AUCₗᵢᵥₑᵣ for the control group of healthy individuals.

18. The method according to claim 17, wherein the standard deviation for GII_{muscle} for the control group of healthy individuals is calculated by dividing AUC_{muscle} for each healthy individual in the control group by the average AUC_{muscle} for the control group of healthy individuals to obtain GII_{muscle} for each healthy individual; and determining the standard deviation for the average GII_{muscle} for the control group of healthy individuals.

19. The method according to claim 17, wherein the standard deviation for GIIₗᵢᵥₑᵣ for the control group of healthy individuals is calculated by dividing AUCₗᵢᵥₑᵣ for each healthy individual in the control group by the average AUCₗᵢᵥₑᵣ for the control group of healthy individuals to obtain GIIₗᵢᵥₑᵣ for each healthy individual; and determining the standard deviation for the average GIIₗᵢᵥₑᵣ for the control group of healthy individuals.
